(19) United States
(12) Patent Application Publication
(10) Pub. No.: US 2008/0198909 A1
(43) Pub. Date: Aug. 21, 2008

(54) Efficient multiple input multiple output signal processing method and apparatus

(76) Inventors: Michail Konstantinos Tsatsanis, Huntington Beach, CA (US); Willen Lao, Foothill Ranch, CA (US); Wei Mo, Mission Viejo, CA (US)

Correspondence Address: WEIDE & MILLER, LTD., 7251 W. LAKE MEAD BLVD., SUITE 530, LAS VEGAS, NV, 89128, US

(21) Appl. No.: 12/011,481

(22) Filed: Jan. 25, 2008

Related U.S. Application Data
(63) Continuation-in-part of application No. 10/800,422, filed on Mar. 11, 2004, now Pat. No. 7,315,592.
Application No. 10/800,422 is a continuation-in-part of application No. 10/717,702, filed on Nov. 19, 2003.
Application No. 10/717,702 is a continuation-in-part of application No. 10/658,117, filed on Sep. 8, 2003.
(60) Provisional application No. 60/897,642, filed on Jan. 25, 2007.

(51) Int. Cl. H04B 1/38; H04B 3/00; H04B 1/10

(52) U.S. Cl. 375/219; 375/350; 375/257; 375/260

(57) ABSTRACT

A multi-channel communication transceiver configured to communicate over multiple channels, such as multiple twisted pair conductors, and implement MIMO processing is disclosed. The MIMO processing occurs in a separate MIMO co-processor, which may be a DSP type processor executing machine readable code or a dedicated MIMO filter. The MIMO co-processor may be located on a separate integrated circuit and interface with the transceiver via one or more data paths and one or more control data paths. Control data is exchanged to facilitate processing of the data in the MIMO filter. A slicer output or an error term, may be forwarded to the MIMO co-processor or generated within the co-processor.

### 1. PRIORITY CLAIM

The application claims priority to and the benefit of U.S. provisional application No. 60/897,642 filed on Jan. 25, 2007 and entitled Efficient Multiple Input Multiple Output Signal Processing Method & Apparatus and is a continuation-in-part and claims priority to U.S. Pat. No. 7,315,592 filed Mar. 11, 2004 entitled Common Mode Noise Cancellation, which is a continuation-in-part of U.S. patent application Ser. No. 10/717,702, filed Nov. 19, 2003, which is a continuation-in-part of U.S. patent application Ser. No. 10/658,117, filed Sep. 8, 2003.

### 2. FIELD OF THE INVENTION

The invention relates to multichannel data transmission systems and removal of interference, e.g., crosstalk, in a multichannel communication system, and more particularly to a method and apparatus for storage and retrieval of coefficients used in the removal of interference in a multichannel communication system.

### 3. RELATED ART

It is commonly accepted practice to transmit data between remote locations over some form of transmission medium. The growing popularity of electronic data exchange is increasing the demand for high rate data transmit speeds between remote locations. Multichannel communication systems have found application in may situations it is desirable to increase the rate of data exchange. The use of multiple channels often increases the effective transmit rate over a single channel system. Examples include wireless communication systems with multiple transmit and multiple receive antennas, DSL systems with multiple copper pairs and Ethernet systems (using four copper pairs per link).

In those examples of multiple physical transmission systems, information is transmitted in a coordinated fashion across the multiple channels to utilize all of the channels of the physical transmission medium. Further, coordinated multichannel signaling can be utilized in applications where a point-to-multipoint communication link is desired. One example is the case where a wireless base station communicates with multiple mobile transceivers. Another example includes the case of DSL access multiplexers in a telephone central office communicating with multiple customer DSL modems in a star network using one pair per customer.

As a drawback to these prior art systems, interference is often a major degradation factor limiting the performance of communication systems. In the single channel transmission systems, intersymbol interference (ISI) is a major impairment and modern transceivers employ a variety of techniques to mitigate it (channel equalization). In multichannel communication systems there is further interference due to interactions across the communication channels. This interaction across communication channels is often referred to as crosstalk. For example, in wireline communications crosstalk is generated due to electromagnetic coupling when copper pairs travel in close proximity for long distances, or even short distances depending on the relative signal strengths. In wireless communications, crosstalk is generated when multiple users transmit signals whose energy partially overlaps in frequency and/or time.

Crosstalk is classified as near end (NEXT) or far end (FEXT) crosstalk depending on the location of the aggressor transmitter, i.e., whether the aggressor transmitter is at the near end or the far end in reference to the victim receiver. Furthermore, in the context of a multichannel system, crosstalk is often classified as self or alien crosstalk. Self crosstalk originates from the transmitters which are part of the coordinated multichannel transceiver. Alien crosstalk originates from the transmitters which are not part of the coordinated multichannel transceiver. Alien crosstalk can be particularly troublesome because it originates from other transmitters or channels (e.g., legacy systems) that are not part of the system under design and to which the system under design does not have access to for purposes of crosstalk cancellation.

Typically, filtering can be used to negate crosstalk, or other interference. Such filtering can be performed in the frequency domain on each frequency subchannel (e.g., DMT or OFDM frequency bin). Multiple Input Multiple Output (MIMO) filtering involves processing data across lines or channels per frequency bin. This approach significantly reduces the computational requirements (compared to performing MIMO filtering in the time domain using time domain filters). However, it requires separate filtering coefficients for each frequency bin. These filtering coefficients must be stored and repeatedly accessed during the filtering process on a bin-by-bin basis. Improvements are therefore needed in the storage and access of filtering coefficients.

In addition, While MIMO type systems provide numerous benefits, such systems also suffer from numerous drawbacks. One such drawback, is that MIMO type transceivers often translate to complex systems due to the multiple channel nature of such systems. In some embodiments, 4 to 25 channels may be combined to transport signal between remote locations. Due to the numerous channels and signals, and the combined and joint concurrent processing on the signals, MIMO capable transceivers are exceedingly complex.

In particular, the computational complexity and coefficient storage requirements grow with the square of the number of channels N (copper pairs or antennas) since most MIMO architectures involve matrix filtering of size N-by-N. In a multicarrier transmission system, such operations have to be repeated for each carrier. This translates into significant implementation obstacles once the number of channels grows beyond 2 or 4, and as the number of carriers grows to a large value. For DSL applications as an example, where MIMO sizes of 8, 16 or 24 channels are envisioned and the number of carrier frequencies can be up to 4096, the implementation complexity becomes particularly intractable.

As a result, prior art MIMO transceivers are undesirably complex and inflexible. There is a need for a MIMO transceiver system which overcomes the drawbacks of the prior art.

### SUMMARY

To overcome the drawbacks of the prior art, the method and apparatus described herein provides efficiencies in storing and accessing filtering coefficients for use in MIMO filtering to remove crosstalk, and/or other interference, in multichannel transmission systems. It is contemplated that any multichannel environment may benefit from the method and apparatus described herein including, but not limited to, twisted copper, coax cable, fiber optic, free space, wireless, or any other metallic or multichannel medium. The term multichannel in this context refers to multiple physical transmission paths as in the case of multi-antenna or multi-copper pair transmission systems, which typically interfere with each other. It does not refer to transmission onto multiple carriers or frequency bands (e.g., OFDM and DMT systems) in a single antenna or single pair system. Typically, in these multi-carrier transmission systems the different frequency channels do not appreciably interfere with each other.

In accordance with the method and apparatus disclosed herein, a method is provided for storing filter coefficients for use with a multiple input, multiple output filter comprising storing a first set of coefficients in memory, the first set corresponding to a first frequency bin, compressing a second set of coefficients corresponding to a second frequency bin, wherein compression of the second set of coefficients is based at least in part on the first set of coefficients, and storing the second set of coefficients.

Also disclosed is a method for accessing filter coefficients for use with a multiple input, multiple output filter comprising retrieving a first set of coefficients from memory, retrieving a second set of coefficients from memory, wherein the second set of coefficients are stored in a compressed form, decompressing the second set of coefficients based at least in part on the first and second sets of coefficients.

Also disclosed is a method for filtering using a multiple input, multiple output filter comprising retrieving a set of prediction error values, each of which corresponds to a filter coefficient for use in filtering a set of input signals in the frequency domain, generating a set of filter coefficients using the retrieved prediction error values, and filtering the input signals using the generated set of filter coefficients.

Also disclosed is a system for storing filter coefficients for use with a multiple input, multiple output filter comprising a storage subsystem storing a first set of coefficients in memory, the first set corresponding to a first frequency bin, and an interface coupled to the storage subsystem configured to compress a second set of coefficients corresponding to a second frequency bin, wherein compression of the second set of coefficients is based at least in part on the first set of coefficients, and wherein the second set of coefficients are stored by the storage subsystem.

In another embodiment, a system is provided for accessing filter coefficients for use with a multiple input, multiple output filter, the system comprises a storage subsystem comprising a memory storing first and second sets of coefficients, the second set of coefficients being stored in a compressed form, and a filtering subsystem. The filtering subsystem comprises an interface configured to retrieve the first and second sets of coefficients from memory, and decompress the second set of coefficients based at least in part on the first and second sets of coefficients.

In another embodiment, a system is provided for multiple input, multiple output filtering using coefficients, the system comprising storage and filtering subsystems. The storage subsystem comprises a memory configured to store a set of coefficient prediction error values, each of which corresponds to a filter coefficient for use in filtering a set of input signals in the frequency domain. The filtering subsystem is coupled to the storage subsystem and comprises an interface configured to retrieve the coefficient prediction error values from memory and to generate a set of filter coefficients using the retrieved coefficient prediction error values. In this manner, the filtering subsystem is configured to filter the input signals using the generated set of filter coefficients.

This embodiment teaches how sets of coefficients, corresponding to sets of frequency carriers can be efficiently stored and retrieved, by using prediction of the coefficients for a particular frequency carrier from the coefficients used for neighboring frequency carriers. It is stressed here that the term prediction refers to predicting the coefficient values used in a particular carrier; it does not refer to predicting the actual signal values and in fact it is not limited to prediction error filter structures. The current subject matter is in fact agnostic to the specific architecture of the MIMO filter and is applicable to several MIMO architectures including but not limited to linear filtering, decision feedback filtering, and transmitter precompensation filtering.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 illustrates a block diagram of an example environment of use of the method and apparatus described herein.

FIG. 2A illustrates a block diagram of an example embodiment of a point-to-point communication system.

FIG. 2B illustrates a block diagram of an example embodiment of a point-to-multipoint communication system.

FIG. 3 illustrates a block diagram of an example embodiment of a transmitter.

FIG. 4 illustrates a block diagram of an example embodiment of a receiver.

FIG. 5 illustrates a block diagram of a model of a channel with an input signal and an output signal.

FIG. 6, which comprises FIGS. 6A and 6B, illustrates block diagrams of a transmitter and receiver, respectively, and examples of components thereof, in accordance with one or more embodiments presently disclosed.

FIG. 7, which comprises FIGS. 7A to 7D, illustrates exemplary block diagrams of a multiple input, multiple output (MIMO) unit, and components thereof, for use in accordance with one or more embodiments disclosed herein.

FIG. 8, which comprises FIGS. 8A and 8B, provides process flow examples for use in accordance with one or more embodiments presently disclosed.

FIG. 9, which comprises FIGS. 9A and 9B, provides a component diagram illustrating compression performed by a MIMO processing module in accordance with one or more disclosed embodiments.

FIG. 10, which comprises FIGS. 10A and 10B, provides component diagram examples illustrating decompression performed by a MIMO processing module in accordance with one or more disclosed embodiments.

FIG. 11, which comprises FIGS. 11A and 11B, provides an example of multipair transceivers coupled to a MIMO processing module in accordance with one or more disclosed embodiments.

FIG. 12 provides an example of a MIMO processing module coupled to multiple transceivers in accordance with one or more disclosed embodiments.

FIG. 13 illustrates a block diagram of multi-channel transceiver with a MIMO co-processor.

FIG. 14 illustrates a detailed block diagram of a transmitter with MIMO co-processor.

FIG. 15A illustrates an exemplary block diagram of a receiver configured to a MIMO co-processor.

FIG. 15B illustrates an exemplary block diagram of a receiver configured to a MIMO co-processor without slicer output feedback to the MIMO co-processor.

FIG. 16 illustrates a more detailed block diagram of a receiver and co-processor arraignment.

FIG. 17 is an exemplary operational flow diagram of an example method of coprocessor operation.

FIG. 18 is an exemplary operational flow diagram of an example method of coprocessor operation.

### DETAILED DESCRIPTION

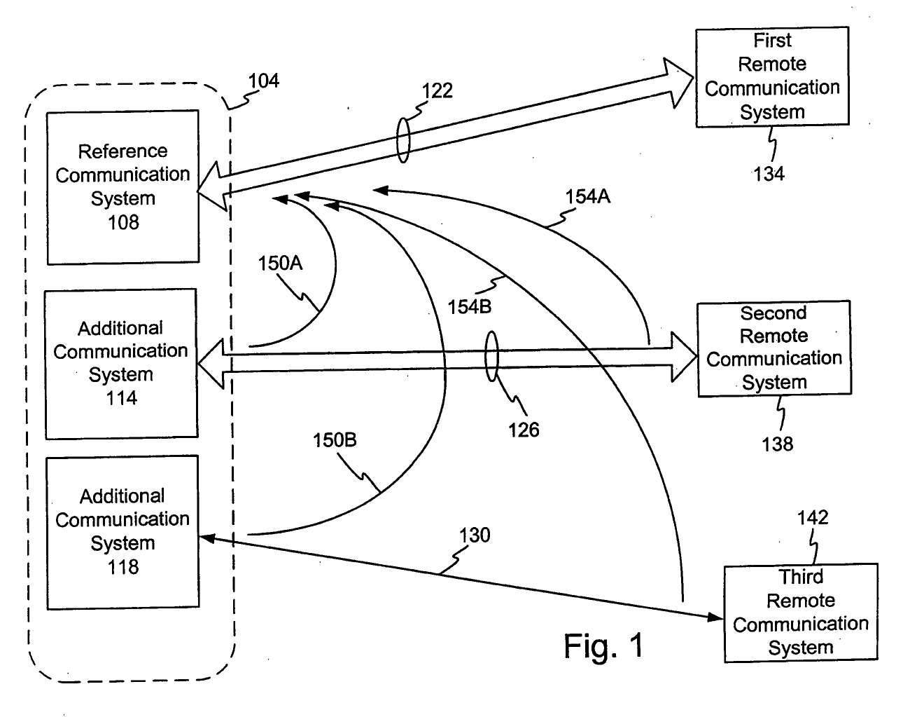

Before discussing the particulars of the claimed method and apparatus, a discussion of example environments for use of the invention may aid the reader in their understanding. FIG. 1 illustrates an example environment of use in accordance with one or more embodiments of the present disclosure. FIG. 1 is provided by way of a non-limiting example, and the embodiments disclosed herein should not be limited to environments of use shown in FIG. 1. As shown a plurality of communication systems or stations is shown, each of which communicates over one or more channels. In particular, located at a first location 104, such as a central office or internet service provider, is a reference communication system 108. In addition, one or more additional communications systems 114, 118 may also be located at the first location 104. The term reference communication system 108 is defined to mean the communications system under design or from which crosstalk analysis occurs. It is contemplated that the communication systems 108, 114, 118 at the first location may communicate with one or more remote locations 134, 138, 142 respectively.

In the example shown in FIG. 1, the reference communication system 108 communicates with the first remote communication system 134 over a multiple channel communication path 122, which may be referred to as the reference channel as it is associated with the reference communication system. Use of the multiple channel communication path 122 allows increased bandwidth over single channel systems. Similarly, the additional communication system 114 communicates with the second remote communication system 138 via a multiple channel communication path 122 while the additional communication system 118 communicates over with the third remote communication system 142 via a single channel communication path 130. The channel discussed herein may comprise any type of signal path such as but not limited to channel twisted pair metallic conductors, wireless, optical, coax, etc. An example of wireline multichannel system is a Gig-Ethernet transmission system over four copper pairs. Another example is a DSL multipair system. Further, an example of a wireless multichannel system may be a system with multiple transmit and receive antennas or a system that transmits over multiple frequency bands.

As can be appreciated, although the remote communication systems 134, 138, 142 may be located at diverse locations, the channels 122, 126, 130 may be in close proximity for at least a portion of the distance of the channel(s). Moreover, since the communication systems 108, 114, 118 are all located the first location 104, it is contemplated that the channels 122, 126, 130 will be in close proximity for at least the distance near the first location, such as for example in the case of twisted pair entering the central office via a common bundle of twisted pair copper cable.

Due to the proximity of the channels 122, 126, 130 it is anticipated the crosstalk will exist on the reference channel 122 due to coupling of the signals on channels 126, 130 onto the reference channel. Such crosstalk is shown in FIG. 1 as alien near end cross talk (NEXT) 150A, 150B and alien far end cross talk (FEXT) 154A, 154B. As is understood by one of ordinary skill in the art the term alien crosstalk signifies that the crosstalk is generated by channel(s) other than those in the one or more channels that comprise the reference channel(s). Although not shown, it is contemplated that the reference channel, being comprised of two or more individual channels or conductors, will also generate crosstalk, which is referred to herein as self crosstalk, due to the proximity of the two or more conductors that comprise the two or more channels 122. Those of ordinary skill in the art understand the nature of self crosstalk and the associated drawbacks and hence it is not described in detail herein.

In one example embodiment the reference communication system 108 and the first remote communication system 134 comprise communication systems configured to operate in accordance with a DSL standard utilizing two or more channels in an effort to maximize the data transmit rate utilizing presently existing twisted pair conductors. In this manner the benefits of presently installed cabling may be realized while also maximizing bandwidth between communication systems. In one embodiment the channel 122 comprises six to fourteen twisted pair conductors, although in other embodiments any number of conductors or conductor pairs may be utilized to gain the benefits of the method and apparatus described herein. In addition, communication standards other than DSL may be adopted for use with the method and apparatus described herein. Thus, the claims that follow should not be construed as being limited to a particular DSL standard, or to particular twisted pair conductors.

In one example environment of use, the method and apparatus disclosed herein is utilized in a multi-channel communication system based on a DSL communication standard. As such, a discrete multi-tone transmission (DMT) scheme is utilized to maximize channel bandwidth and overcome processing challenges created by ISI. In one embodiment the method and apparatus described herein operates on each frequency bin. In one embodiment this comprises 256 different tones and the processing described herein may operate on each tone. In other embodiments a different number of tones may be utilized. While it is contemplated that time domain filters may be utilized for processing in the time domain, in the embodiment described herein processing occurs in the frequency domain.

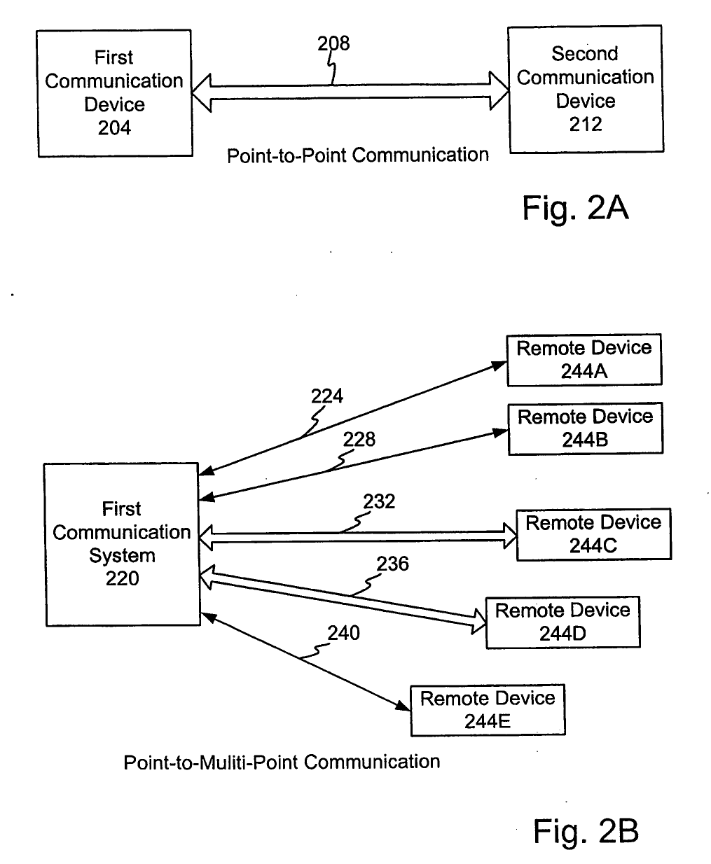

FIG. 2A and FIG. 2B illustrate two exemplary communication system configurations for use with the method and apparatus described herein. It is contemplated that the method and apparatus described herein may be applied to both point-to-point and point-to-multipoint communication systems and additional other communication system configurations as may be enabled by one or ordinary skill in the art.

FIG. 2A illustrates an example embodiment of a point-to-point communication system configuration. As shown a first communication device 204 communicates via a multi-channel communication path 208 with a second communication device 212. Through use of the multi-channel communication path and the processing as described herein, increased data transmit rates may be achieved, as compared to the prior art, while utilizing existing communication medium. It is contemplated that the multi-channel path 208 may comprises a wired, such as metallic conductor or optic, path, or wireless or free space medium.

FIG. 2B illustrates an example embodiment of a point-to-multipoint communication system. As shown a first communication system 220 communicates with two or more remote devices 244A, 244B, 244C, 244D, 244E via the communication paths 224, 228, 232, 236, 240. In this example embodiment communication paths 224, 228 and 240 comprise single channel communication paths while paths 232, 236 comprise multi-channel communication paths. Examples of point-to-multipoint communication systems include, but are not limited to a wireless base station that communicates with multiple mobile transceivers. Another example comprises a DSL access multiplexer in a telephone central office communicating with multiple customer DSL modems in a star network using one pair per customer. In such a configuration, the disclosed invention can be practiced in a different manner in the upstream direction (remote devices to central system) and the downstream direction (central system to remote devices). In particular, in the upstream direction the disclosed invention can be practiced by the receiver of the central system and can operate on the received upstream signals. On the other hand, in the downstream direction, the invention can be practiced by the transmitter of the central system, and can operate on the signals prior to their transmission on the multichannel communication medium. To those skilled in the art, this is generally referred to as “transmitter pre-processing” of the communication signals. Of course, other configurations are possible that would likewise benefit from the teachings contained herein.

With regard to multi-channel communication path systems, multichannel communication systems have found application in situations where one can utilize multiple physical paths or channels from transmitter to receiver to convey information. Examples include wireless communication systems with multiple transmit and multiple receive antennas, gigabit Ethernet systems (using four copper pairs per link), and DSL multipair transmission systems, to name but a few. Through the use of multi-channel paths and the method and apparatus described herein, synergy exists in that the overall bandwidth or data rate possible with the multi-channel path and associated signal processing is greater than the sum of an equal number of single channel communication systems operating individually, such as in a multiplexed configuration. As a result, information is transmitted and processed, both prior to and after transmission, in a coordinated fashion across all channels to maximally utilize the available physical transmission medium. As a result of these benefits, the method and apparatus described herein exploits the multi-channel path environment.

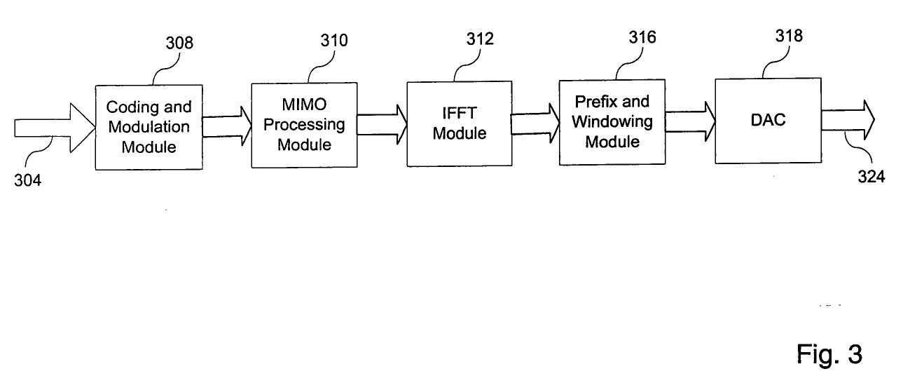

Turning now to FIG. 3, a block diagram of an example embodiment of a transmitter is shown. Although it is contemplated that the principles described herein may be utilized with any transmission standard, modulation scheme, or encoding scheme, in this example embodiment a vectored DMT transmission system is adopted for use. The transmitter shown in FIG. 1 comprises a DMT transmission system in which a collection of all the signals to be transmitted from all the available channels are processed in sync, with synchronous clocks and frame aligned, through the DMT transmitter blocks as shown.

As stated above, the processing described herein may be utilized with any communication standard or scheme. Mitigation of intersymbol interference in a single channel (as well as multichannel) system may be accomplished by appropriate transmitter and receiver filtering (channel equalization). With regard to a DMT system, DMT modulation divides the available bandwidth in multiple parallel frequency channels (tones) and transmits information bits on each tone according to each tone's information capacity. DMT has the benefit of high performance and low complexity as compared to other prior art methods. For example, use of DMT may mitigate numerous intersymbol interference issues.

As shown an input 304 from a network device, computers, switch, or any communication or source device is received at a coding and modulation module 308 for processing in accordance with one or more coding and modulation schemes. In one embodiment the coding and modulation comprises such as may occur with DMT type coding and modulation. U.S. Pat. No. 5,673,290, which is incorporated by reference, provides general information and background regarding DMT type communication transmitters and processing. In one embodiment the output of the coding and modulation module 308 comprises a multi-channel path carrying 256 values which are represented as a magnitude and phase and which at this stage in the processing may be in the frequency domain. As DMT type coding and modulation is generally understood by one of ordinary skill in the art, it will not be described in detail herein. It should be noted that the input 304 to the coding and modulation module 308 may comprise a multi-conductor or multi-channel module and the number of channels associated therewith may be dependant upon the number of channels utilized for communication between remote locations and the particular design choices for of the system designers. The input 304 may also comprise a high speed serial input.

The output of the coding and modulation module 308 feeds into the MIMO processing module 310 and then into IFFT module 312 (inverse Fast Fourier Transform). In accordance with embodiments disclosed, MIMO processing module 310 processes the multiple inputs to negate or account for the channel matrix's effect on the channel and the noise v(n) so that the original signal may be recovered and performance requirements maintained. The IFFT module 312 processes the incoming data by performing an inverse Fast Fourier Transform on the incoming data. The transformed data is in turn provided to a prefix and windowing module 316 that is configured to append needed leading and trailing samples of a DMT symbol and other processed data. In one embodiment this comprises time domain multiplication of each real sample by a real amplitude that is the window height. This allows for a smooth interconnection of the samples, which in turn may decrease noise leakage across bins in the frequency domain. The output of the prefix and windowing module 316 is eventually received at one or more digital to analog converters 320 that transform the data into one or more analog signals, which are to be transmitted over one or more channels. It is contemplated that other or additional processing modules or systems may be included within the transmitter but which are not shown. It is also contemplated that the output channel 324 may comprise a plurality of channels, paths or conductors. As suggested above the output 324 may comprise two or more twisted pair conductors.

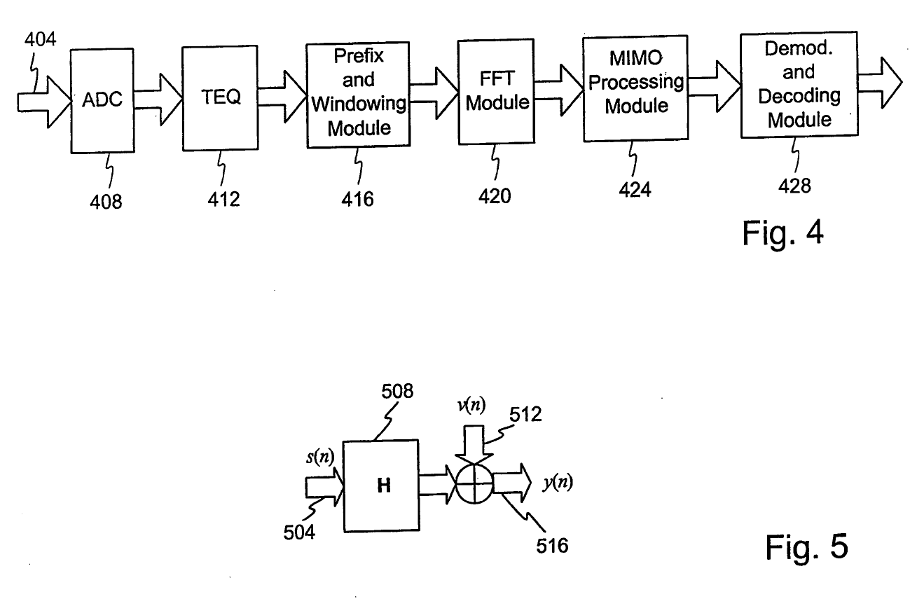

FIG. 4 illustrates a block diagram of an example embodiment of a receiver. The configuration of FIG. 4 is provided for purposes of discussion and not limitation as it is useful in understanding how the method and apparatus of the present invention relates to the other functional aspects of a receiver. As shown, an input 404 is configured to receive an input signal from a transmission medium or one or more intermediate devices that may reside between the transmission medium and the input, such as a transformer or other device. The transmission medium may comprise two or more physical channels. As it is contemplated that the receiver of FIG. 4 be utilized in a multi-channel environment, the input 404 may comprise a parallel line comprising numerous conductors or channels. Similarly, the devices shown in FIG. 4 and throughout this document may consist of one or more such devices as may be necessary to meet the processing requirements described herein. Thus, in the case of FIG. 4, if the channel 404 were to comprise twelve channels, then the ADC block 408 may comprise twelve individual ADC devices.

The input 404 provides one or more received signals to one or more analog to digital converters (ADC) 408 that convert the one or more incoming signals to a digital format for subsequent processing. Thereafter one or more a time domain equalizers (TEQ) 412 receive and process the one or more signals to reduce or negate the effects of transmission of the signal through the one or more channels. Any type equalization may occur.

After equalization, one or more prefix and windowing modules 416 perform an optional windowing and/or prefixing operation on the one or more signals as would be understood by one of ordinary skill in the art. After the optional windowing operation, one or more FFT modules 420 perform a Fourier Transform on the one or more signals. Any type Fourier Transform may occur including a Fast Fourier Transform operation. The FFT module 420 output(s) are provided to a multiple MIMO processing module 424 that is configured to receive the multiple inputs of the multi-channel input to the receiver and perform processing as is described below in greater detail. In the embodiment described therein, MIMO processing module 424 performs processing on the two or more signals to account for the affects of the channel and coupling that may have occurred during transmission. MIMO processing is described below in more detail. The processing that occurs prior to the MIMO processing module may be referred to herein as receiver pre-processing or simply pre-processing.

The output of the MIMO processing module 424 is provided to a de-modulation and decoding module 428 that is configured to de-modulate and decode the one or more received outputs from the MIMO processing module. In one embodiment the demodulation and decoding module 428 reverses the modulation and encoding performed by the transmitter if such was performed. In one embodiment this comprises QAM type modulation and encoding. It is also contemplated that error correcting coding type modulation may occur. In one embodiment, Trellis Coded Modulation may be used. In another embodiment, turbo coding or other coding schemes may be employed.

Thereafter, the one or more signals may be provided to one or more subsequent down stream systems for additional processing or for use by an end user or other system. In a multi-channel communication system each of the multiple channels in the communication system generates cross talk and, in addition, adjacent or nearby channels that are not part of the communication system, but instead associated with other communication systems, will also contribute crosstalk.

In one embodiment the output of the FFT module 420 comprises a total of 256 tones on each of fourteen physical channels or lines for each block, symbol, or register transfer. It is contemplated that the MIMO block 424 may jointly process all of the fourteen physical channels for each of the 256 tones. Thus processing may occur on one frequency at a time (fourteen channels) as the system cycles through the 256 frequencies, which represent the data. In various different embodiments a different number of channels may be used to provide the requested or desired bandwidth, i.e. data exchange capacity. Although any number of channels may be used, the range of four to sixteen channels may be selected in many applications.

FIG. 5 illustrates an example embodiment of a block diagram based on the mathematical model for the received signals at the output of the FFT module 420 or the input to the MIMO processing module 424. As shown in FIG. 5, a number, M, input signals for a particular bin n, shown as s(n) 504, are being acted upon by the channel, which may represented as an channel matrix 508 to account for the numerous interactions between self channel coupling. The addition of additive interference or noise, v(n) 512, corresponding to the input signals s(n) 504, is also shown to account for alien crosstalk. The resulting output, y(n) 516, represents a number, M, output signals for a particular bin n, that have passed through and been acted upon by the channel and signals on adjacent channels, i.e. both alien and self NEXT and FEXT. More simply, the signal y(n) 516 to be provided to the MIMO processing module 424 of FIG. 4 is generated by the transmission of the original signal through the channel where the signal on each of the two or more channels is acted upon by self crosstalk, represented by the channel matrix 508, and noise and alien crosstalk, represented by v(n) 512. In accordance with embodiments disclosed, MIMO processing module processes the multiple inputs to negate or account for the channel matrix's effect on the channel and the noise v(n) so that the original signal may be recovered and performance requirements maintained.

This can be shown mathematically by the following equation:

y(ωᵢ)=H(ωᵢ)s(ωᵢ)+v(ωᵢ)

where H(ωᵢ) represents the M×M FEXT channel matrix (assuming M parallel channels), s(ωᵢ)=[s₁(ωᵢ), . . . , s_{M}(ωᵢ)]^{T} is the transmitted vector and v(ωᵢ) is the additive interference plus noise. Since v(ωᵢ) may be NEXT dominated, it is not assumed to be spatially white, but possesses a spatial correlation matrix E{v(ωᵢ)v(ωᵢ)^{H}}=Rᵥ.

To reduce the complexity of the notation, in the text that follows, the explicit reference to frequency in the signal equations is dropped. This description illustrates that the impairments across lines are limited to within a particular bin, and therefore suggests that the MIMO processing block can operate on a bin by bin manner. A bin, as way of background, comprises a finite range of frequencies that is a subset of the entire available bandwidth. The available bandwidth may be divided into numerous bins and data transmitted within one or more of the bins to thereby segregate data transmission into the various and appropriate frequency bins. Thus, within the MIMO processing module 424 shown in FIG. 4, the crosstalk components that have coupled onto each channel may be accounted for so that the originally transmitted signals may be recovered.

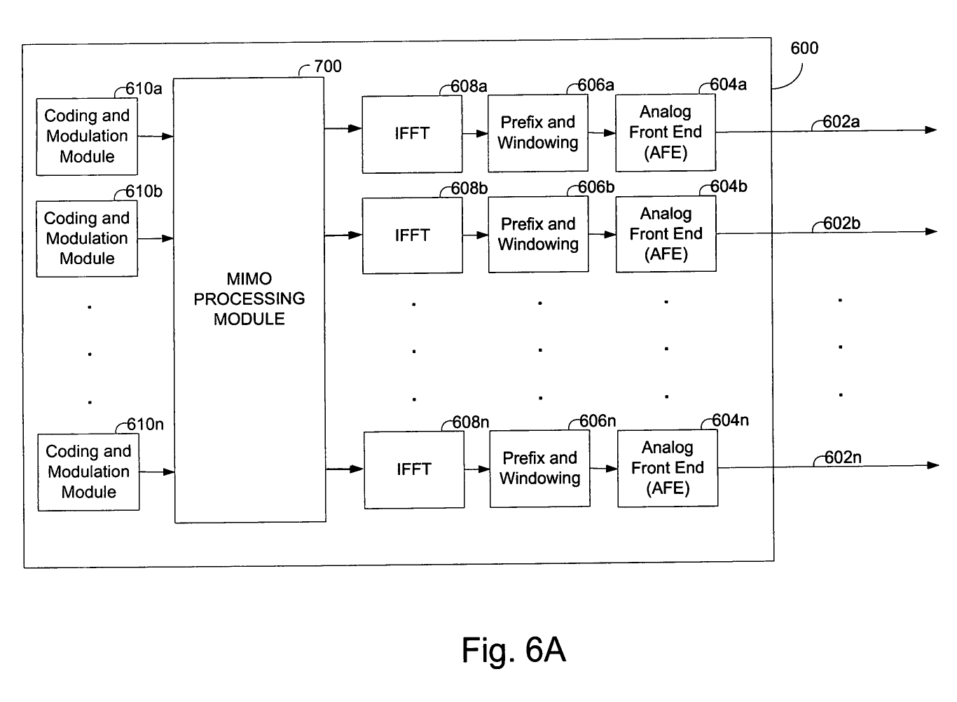

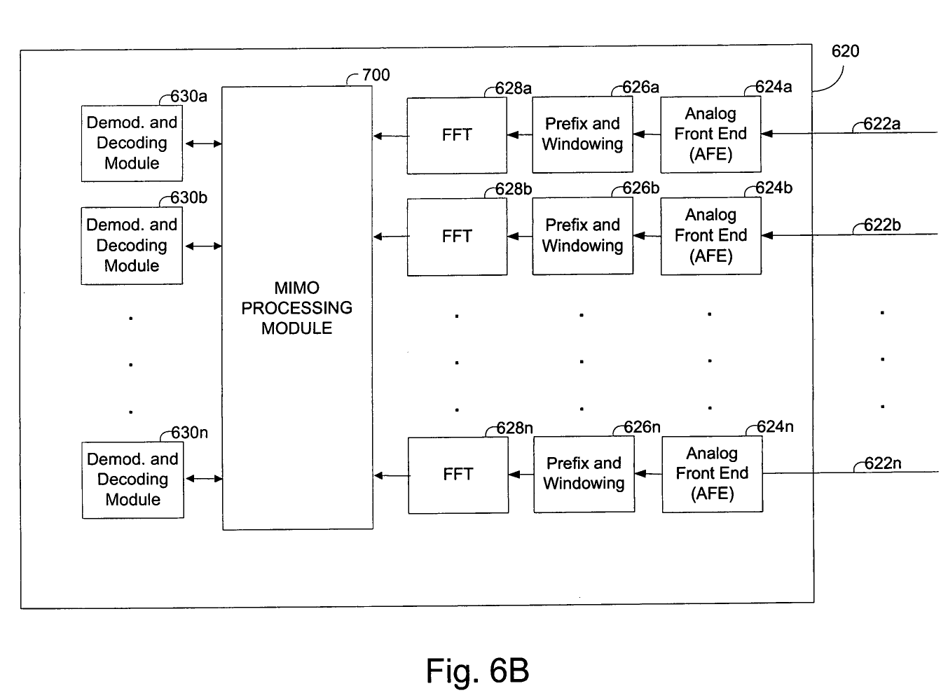

Referring again to FIGS. 3 and 4, block diagrams are shown illustrating a transmitter and receiver, respectively, each of which process multiple channels. The transmitter of FIG. 3 can process input from two or more channels, and the receiver shown in FIG. 4 can generate output for two or more channels, for example. FIG. 6, which comprises FIGS. 6A and 6B, illustrates block diagrams of a transmitter and receiver, respectively, and examples of components thereof, in accordance with one or more embodiments presently disclosed.

Referring to FIG. 6A, a block diagram of a transmitter is shown, which processes multiple channels and uses a MIMO processing module in accordance with one or more embodiments presently disclosed. Transmitter 600, which can be a DMT or OFDM transmitter for example, comprises a number of channels, a to n, each channel providing signal input to be processed by a corresponding coding and modulation module 610, IFFT module 608, prefix and windowing module 606 and AFE module 604. For a given channel, a to n, coding and modulation module processes a signal received from a device, such as a network device, computer, switch, etc., in accordance with one or more coding and modulation schemes. The output of the coding and modulation module 610 in input to MIMO module 700, which acts on the input to negate interface and recover the original signal. Channel output from the MIMO module 700 is fed to each of the respective IFFT modules 608, which processes the signal output by the MIMO module 700 and performs an inverse Fast Fourier Transform on the received signal. The transformed data is in turn provided to a prefix and windowing module 606, which processes the signal as discussed herein. The output of the prefix and windowing module 316 is received at one or more digital to analog converters 320 that transform the data into one or more analog signals, 602.

In accordance with one or more embodiments, MIMO module 700 operates in the frequency domain. In such a case, output from coding and modulation module 610 is in the frequency domain. In addition and in accordance with such embodiments, MIMO module 700 interrupts the signal chain of each transmitter after coding and modulation module 610 and prior to input to the IFFT module 608, and the signals corresponding to channels a to n are jointly processed and pre-compensated for crosstalk, or other interference, on a frequency bin (i.e., bin) by frequency bin basis before the signals are interjected back into the signal chain for further processing and transmission by transmitter 600.

FIG. 6B, illustrates a block diagram of a receiver which processes multi-channel input and uses a MIMO processing module in accordance with one or more embodiments presently disclosed. Receiver 620 receives input 622 from multiple channels, a to n. The input from each channel being processed by an analog front end (AFE) module, e.g., an ADC and TEQ 624, a prefix and windowing module 626, an FFT module 628, MIMO processing module 632, and a demodulator and decoding module 630. The output of each FFT module 628 is provided to MIMO processing module 632, which is configured to receive the multiple inputs of the multi-channel input to the receiver and perform to negate interference. The output of the MIMO processing module 632 is provided to each channel and its respective de-modulation and decoding module 630, which is configured to de-modulate and decode the one or more received outputs from the MIMO processing module. In one or more embodiments, the demodulation and decoding module 630 reverses the modulation and encoding performed by the transmitter if such was performed.

As shown in FIG. 6B, the signal from each channel, a to n, is intercepted by MIMO processing module 632, which operates on the signals from the channels a to n jointly and in the frequency domain on a bin by bin basis. In accordance with one or more embodiments, the MIMO processing module 632 of receiver 620 can use feedback regarding previous decision on other channels.

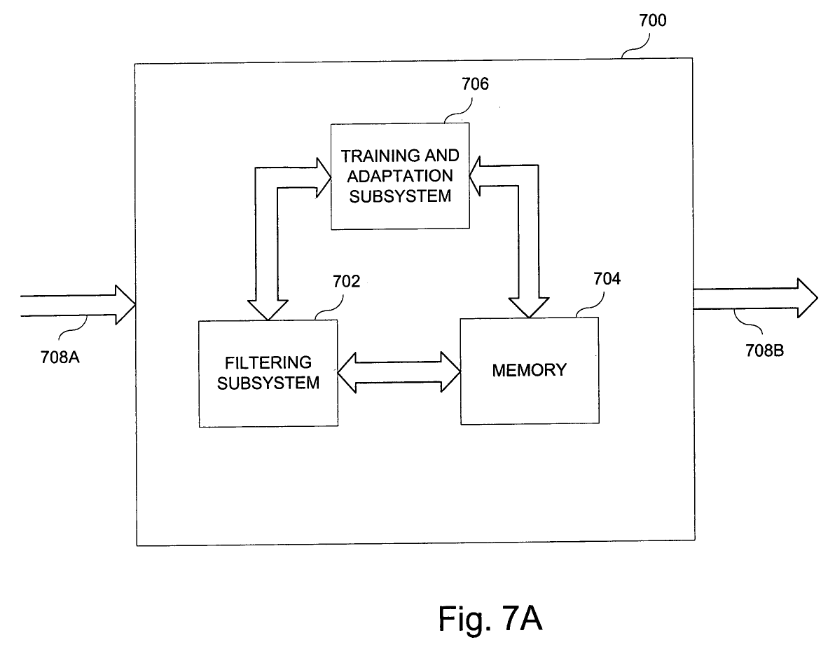

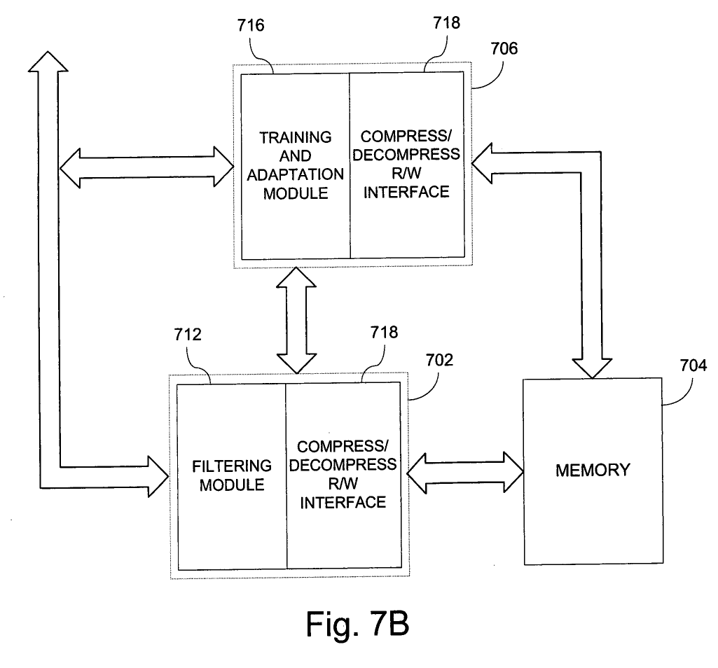

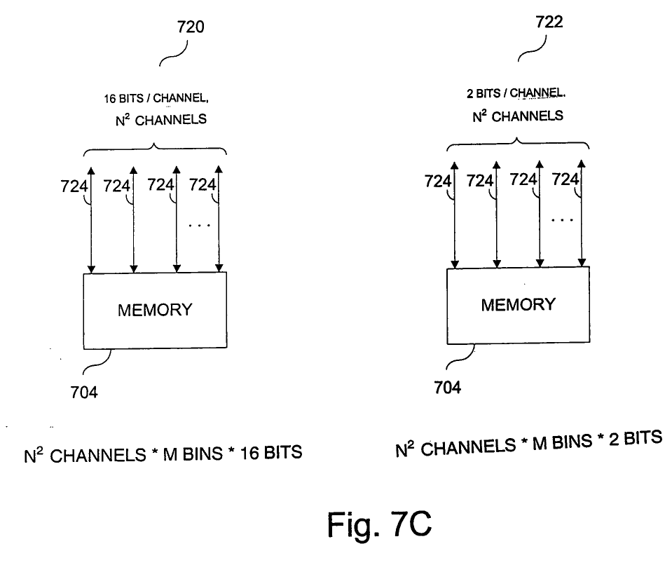

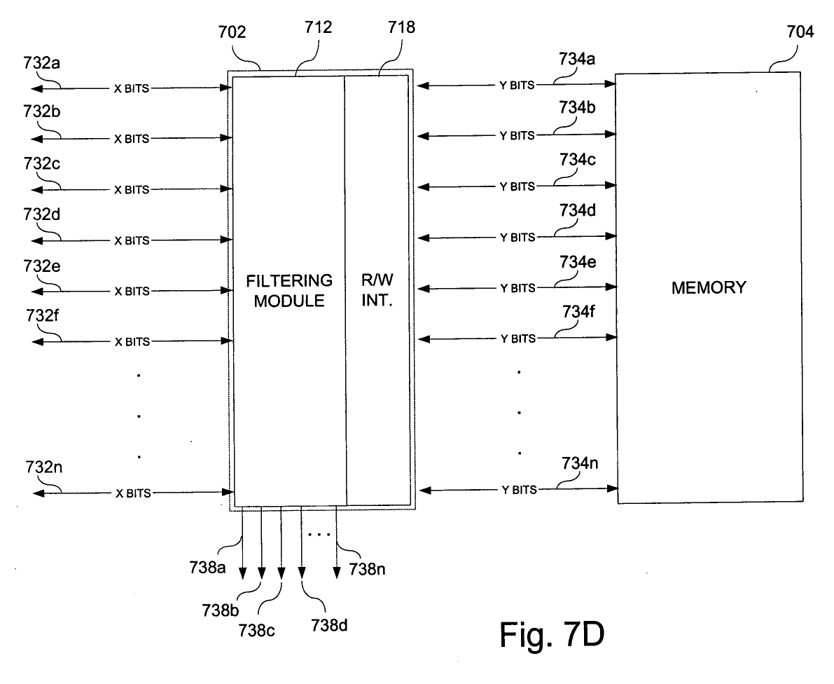

FIG. 7A provides an example of a block diagram of MIMO processing module 700, in accordance with one or more embodiments disclosed herein. The components shown, and any other components that compose MIMO processing module 700, can be implemented in hardware, software or a combination of hardware and software. In accordance with the non-limiting example shown, MIMO processing module 700 comprises a filtering subsystem 702, configured to filter the signals provided using filter coefficients stored in memory 704. In accordance with at least one embodiment, the filtering subsystem 702 can be implemented using a dedicated signal processor, for example. A training and adaptation subsystem 706 is configured to generate and update coefficients that are to be used by filtering subsystem 702. It is contemplated that training, adaptation, or both may occur on the coefficients to tailor the performance of any of the filters described herein to the particular needs of the system and to maintain performance, for example. In one embodiment the adaptation occurs in real time or periodically to maintain system performance and thereby adjust to changes in temperature, coupling, or other factors. The training and adaptation subsystem 706 can be implemented using a programmable digital signal processor, for example. A memory 704 is configured to store the coefficients generated/updated by training and adaptation subsystem and used by the filtering subsystem 702.

Interfaces 708A and 708B comprise a high speed communication path, such as a high speed bus, for providing input to, and output from, the MIMO processing module 700, respectively. For example, referring to FIGS. 6A and 6B, an interface 708A can be positioned between the coding and modulation module 610 of FIG. 6A, or the FFT 628 of FIG. 6B. The MIMO module 700, and the interface 708B can be positioned between the IFFT 608A of FIG. 6A, or the demodulating and decoding module 630 of FIG. 6B, and the MIMO module 700. In addition, the MIMO module 700 can exchange control information through a control interface (not shown), for use with MIMO training and adaptation, for example. By way of non-limiting example, control information can include transmission gain setting per frequency bin, signal to noise ratio per frequency bin, etc.

One or more embodiments of the present disclosure comprise a memory interface that compresses the filtering coefficients on the fly as they are written into memory, and correspondingly decompresses the coefficients as they are used by the filtering subsystem 702. In accordance with at least one embodiment, the filtering performed by the MIMO module 700 can operate in a predetermined manner sweeping through the frequency bins and retrieving the filtering coefficients in a sequential manner. Such embodiments take advantage of the fact that changes in coefficients from one frequency bin to another may be small, since crosstalk coupling functions in most applications have a continuous frequency response such that the variance is not significant across neighboring frequency bins. Thus, it is possible to determine a filtering coefficient corresponding to a particular frequency bin given the filtering coefficient for a neighboring frequency bin and a difference, e.g., an estimated or actual difference, between the two filtering coefficients. Embodiments of the present disclosure gain efficiencies in storage, e.g., the amount of storage needed for the memory 704 and the transfer rates between the memory 704 and the filtering subsystem 702, as well as the memory 704 and the training and adaptation subsystem 706.

By way of a non-limiting example, given a filtering coefficient, Cₙ, which corresponds to a given frequency bin, n, a value of filtering coefficient, Cₙ₊₁, which corresponds to another frequency bin, n+1, can be expressed as:

Cₙ₊₁=Cₙ+eₙ₊₁, Eq. (1)

where eₙ₊₁ comprises a difference between Cₙ₊₁ and Cₙ. Due to “smoothness” properties of neighboring filter coefficients, it is likely that eₙ₊₁ will be a much smaller value that the value of the filtering coefficient cₙ₊₁. Since the value is smaller, a fewer number of bits is needed to store eₙ₊₁, as compared to cₙ₊₁, and the amount of memory 704 needed to store filtering coefficients can thereby be reduced. Furthermore and in addition to efficiencies gained in storage, efficiencies can be gained in communicating eₙ₊₁ in place of Cₙ₊₁.

There exist several prediction error compression methods based on Eq 1, like DPCM and others, and the details of the exact implementation are widely available in textbooks and known to the skilled in the art.

In accordance with one or more embodiments of the present disclosure, a compress/decompress read/write interface is used to compress and decompress filter coefficients. As discussed above, by way of a non-limiting example, compression can be achieved by determining a difference between a coefficient, Cₙ, and a neighboring coefficient, Cₙ₊₁, and decompression can be performed for a coefficient, Cₙ₊₁, using Eq. (1). It should be mentioned here that Eq. (1) provides only a general idea of prediction error compression. The skilled in the art will understand that this process is iterative in always increasing values of index n. The skilled in the art will also understand that if the error term eₙ₊₁ is only allowed to have a small number of bits, Eq (1) may only be an approximation. Therefore, the recursion of Eq (1) may use a true or approximate value of coefficient Cₙ, denoted as Ĉₙ, and can take the form

Cₙ₊₁=Ĉₙ+eₙ₊₁ Eq. (1a)

In accordance with one or more such embodiments, the filtering subsystem 702 and the training and adaptation subsystem 706 comprise an interface to the memory 704 configured to perform compression and decompression for a given coefficient, Cₙ₊₁, using an actual or approximate value Ĉₙ for coefficient, Cₙ, and the difference, eₙ₊₁, and Eq. (1). More particularly and with reference to FIG. 7B, the filtering subsystem 702 comprises a filtering module 714 and interface 718, and a training and adaptation subsystem 706 comprises a training and adaptation module 716 and a interface 718.

Interface 718 can be used to determine a coefficient using an estimated value value for a previous coefficient and a determined coefficient prediction error for the current coefficient. For example, interface 718 can be used to reconstruct C₂, C₃, . . . , Cₙ by reading e₂, e₃, . . . , eₙ based on an initial coefficient, C₁, using Eq. (1).

Conversely, interface 718 can be configured to generate an error, e, for a given coefficient using a variance of Eq. (1), such as that shown in Eq. (2) below, for example:

eₙ₊₁=Cₙ₊₁−Cₙ, Eq. (2)

such that eₙ₊₁ is the difference between coefficient values Cₙ₊₁ and Cₙ. If that difference is quantized to a small number of bits, Eq (2) is only an approximation, and the error is more accurately calculated as

eₙ₊₁=Cₙ₊₁−Ĉₙ Eq. (2a)

It should be apparent, however, that Eq. (2) is one example of a manner in which eₙ₊₁ can be determined, and that other methods can be used to predict a differential between coefficients. In addition, any prediction method by which a given digital signal is predicted using a known, or estimated, values of one or more other digital signals now known or contemplated in the future can be used. In accordance with one or more embodiments, a generalized example of a formula for predicting a filter coefficient can be expressed as follows:

Cₙ₊₁=f(Cₙ,Cₙ₋₁, . . . )+eₙ₊₁,

and a generalized example of a formula for determining an prediction error can be expressed as follows:

eₙ₊₁=Cₙ₊₁−f(Cₙ,Cₙ₋₁, . . . ),

Reference is made to FIG. 7C, which provides examples of efficiencies that can be achieved using one or more embodiments presently disclosed. Referring to scenario 720 for example, a coefficient can comprise sixteen bits. In a case that there are N² channels 724, (corresponding to the N² coefficients per bin), the N² coefficients comprise N²*16 bits. The process of retrieving the N²*16 bits is repeated for each bin, and memory 704 stores N²*16 bits for each bin. In accordance with one or more embodiments, however, by compressing all but an initial set of coefficients, it is possible to reduce the amount of memory 704 needed and increase the transfer rate to/from memory 704, for example. Referring to scenario 722, for example, in a case that a predicted error is stored in place of at least some of the coefficient values, which have a 16-bit representation, and the predicted error is 2 bits in length, a savings of 14 bits can be achieved in storage and transfer. Such a savings is multiplied across the number of bins for which the reduced coefficient representation, e.g., the prediction or error value, is used.

As set forth above, the computational complexity and coefficient storage requirements grow with the square of the number of channels N (copper pairs or antennas) since most MIMO architectures involve matrix filtering of size N-by-N. In a multicarrier transmission system, such operations have to be repeated for each carrier. This translates into significant implementation obstacles once the number of channels grows beyond 2 or 4, and as the number of carriers grows to a large value. For DSL applications as an example, where MIMO sizes of 8, 16 or 24 channels are envisioned and the number of carrier frequencies can be up to 4096. Thus, the complexity and amount of data to be exchanged is immense.

In accordance with one or more embodiments, however, by compressing all but an initial set of coefficients, it is possible to reduce the amount of memory 704 needed and increase the transfer rate to/from memory 704, for example. Referring to scenario 722, for example, in a case that a predicted error is stored in place of at least some of the coefficient values, which have a 16-bit representation, and the predicted error is 2 bits in length, a savings of 14 bits can be achieved in storage and transfer. Such a savings is multiplied across the number of bins for which the reduced coefficient representation, e.g., the prediction or error value, is used.

FIG. 7D provides an example of various input/output (I/O) of filtering subsystem 702 in accordance with one or more disclosed embodiments. As discussed, the filtering subsystem 702 comprises the filtering module 712 and the interface 718. The interface 718 may be configured to perform compression and/or decompression. The lines 732a to 732n can carry the input signals to the filtering subsystem 702. The value n may comprise any whole number. Each of the lines 732 can transfer any number of bits, x, e.g., 16 bits. The interface 718 of the filtering subsystem 702 fetches coefficients from, and outputs coefficients to, the memory 704 via the lines 734a to 734n. Each of the lines 734 can transfer any number of bits, y. In a case that the lines 734 transfer compressed coefficient values, y can be a number less than the number of bits needed to represent a coefficient. For example, in a case that a coefficient is represented using 16 bits, y has a value of 2 bits. The compressed coefficients transferred from the memory 704 via lines 734 are decompressed by the interface 718. The decompressed coefficients are then used by the filtering module 712 to filter the input signals received via lines 732. The filtered result is output from the filtering module 712 via the lines 738. In accordance with one or more embodiments the signal input received via the lines 732, the coefficients fetched from the memory 704 via the lines 734, and the filtered result output via the lines 738 correspond to a given frequency bin. The filtering subsystem 702 iteratively receives the signal input via the lines 732, the coefficients via the lines 734 and outputs the filtered result via the lines 738 on a bin-by-bin basis. By reducing the number of bits needed to represent the filter coefficients in accordance with embodiments of the present disclosure, efficiencies are achieved in the communication of these coefficients between the filtering subsystem 702, and in the storage of the coefficients in the memory 704.

For the sake of another non-limiting example, assume that there are 1000 frequency bins and that there are 4000 sets of tones per second. In such a case, there would be 4 million filtering operations per second, with each frequency bin having a set of filtering coefficients. By reducing the representation some number of the coefficients to a fraction of the size of the actual coefficient (e.g., one-eight in a case of a 16-bit to 2-bit reduction), it should be apparent that significant efficiencies, and that such efficiencies increase as the number of pairs, or matrices, increase.

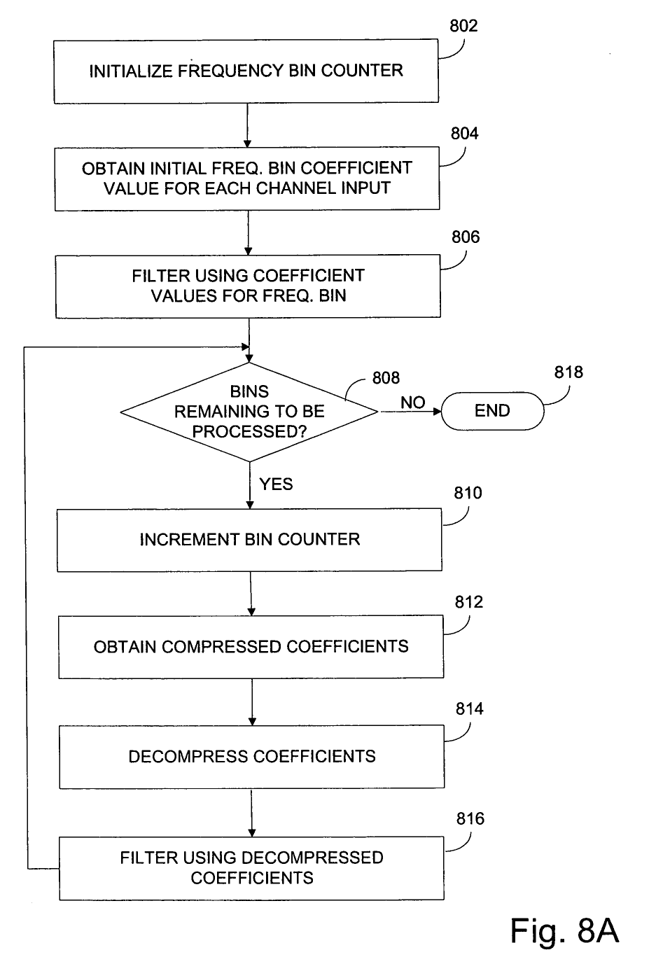

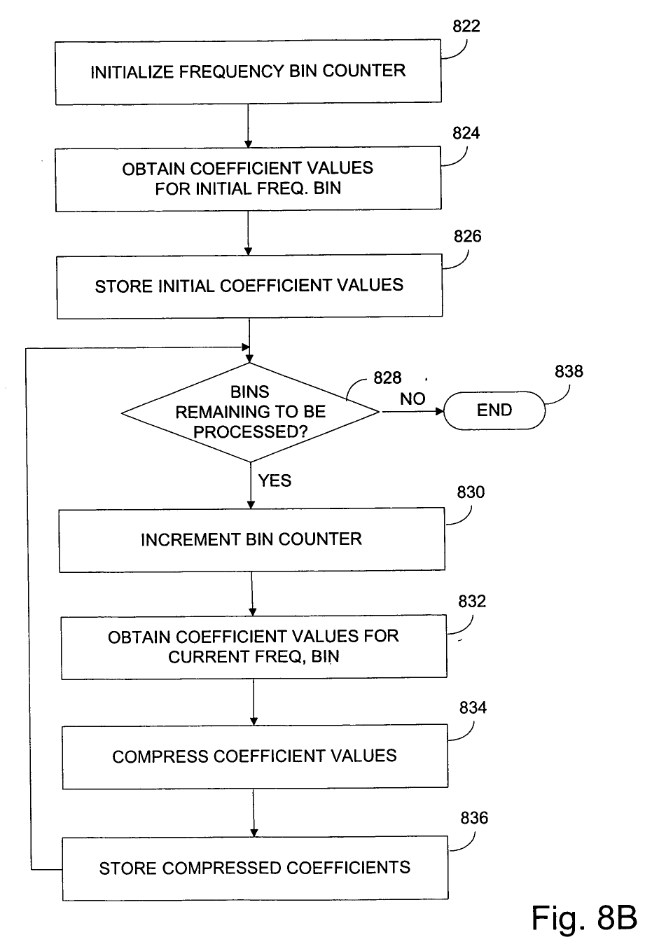

Referring to FIG. 8A, an example flow diagram of a filtering process flow which uses compressed filtering coefficients for use in accordance with one or more disclosed embodiments is provided. The example process flow can be executed by filtering subsystem, for example. At step 802, a frequency bin counter is initialized to an initial frequency bin. At step 804, an initial coefficient value is obtained for each channel input. The coefficient values can be fetched from memory, for example. At step 806, the input for each channel corresponding to the initial frequency bin is filtered using the fetched bin coefficients, and the result is output. At step 808, a determination is made whether or not any bins remain to be processed. If not, processing ends at step 818. If any bins remain to be processed, processing continues at step 810 to increment the bin counter, and to obtain a set of compressed coefficient values, e.g., a predicted error value, at step 812. At step 814, the compressed coefficient values are decompressed. For example, a predicted error value for a given coefficient is added to a previous value of the given coefficient. At step 816, input for each channel corresponding to the current frequency bin is filtered using the decompressed filtering coefficients, and the filtered result is output. Processing continues at step 808 to process any remaining bins.

Referring to FIG. 8B, an example of a process flow for storing compressed filtering coefficients for use in accordance with one or more disclosed embodiments is disclosed. The example process flow can be implemented using training and adaptation subsystem, for example. At step 822, a frequency bin counter is initialized to an initial frequency bin. At step 824, a coefficient values are obtained for an initial frequency bin, and the initial coefficient values are stored, e.g., in memory. At step 828, a determination is made whether or not there are any frequency bins remaining to be processed. If not, processing ends at step 838, or the process can repeat for the next symbol. If there are bins remaining to be processed, processing continues at step 830. In the example shown in FIG. 8B, compressed values, or prediction error values, are determined using identified values for the coefficients corresponding to the current frequency bin. At step 834, the current bin's coefficient values are compressed based on the coefficient values corresponding to one or more previous frequency bins and the coefficient values of the current frequency bin. The compressed coefficients are stored at step 836.

In accordance with one or more embodiments, the coefficient values used in the process flows shown in FIGS. 8A and 8B can be actual or estimated coefficient values. For example, in a case of an estimated coefficient value, such value can be estimated using a prediction value associated with the coefficient.

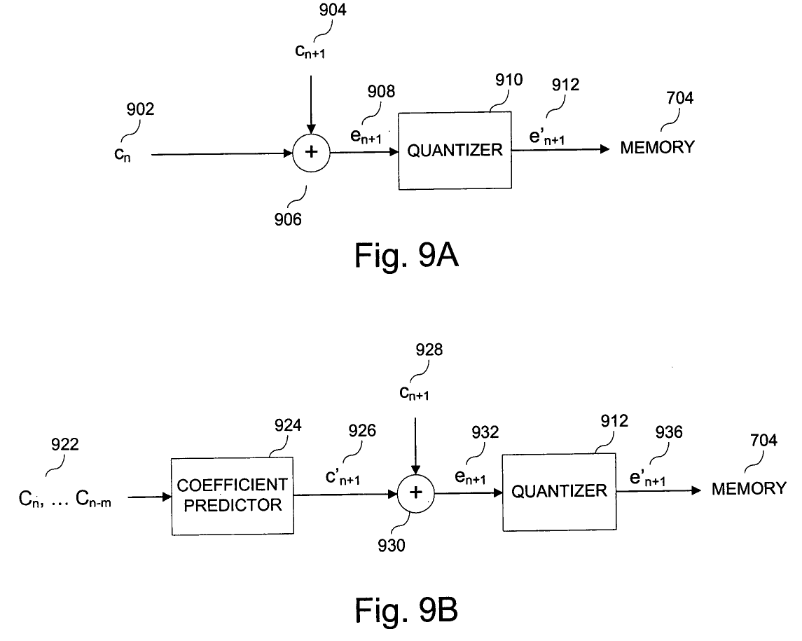

FIG. 9, which comprises FIGS. 9A and 9B, provides a component diagram illustrating compression performed by a MIMO processing module, e.g., interface 718, in accordance with one or more disclosed embodiments.

Referring to FIG. 9A, coefficient values, Cₙ₊₁ 904, and true or approximate coefficient values of Cₙ 902, are input to an adder 906 to generate a prediction value, eₙ₊₁. At this point, the prediction value 908 has the same precision, e.g., 16 bits, as the coefficient values. The prediction value 908 is input to quantizer 910 to generate a prediction value, e′ₙ₊₁, which is output and stored to memory 704.

In the example shown in FIG. 9A, actual or approximate (estimated) coefficient values can be used. Alternatively estimated values for some or all of the coefficient values can be used. In the example shown in FIG. 9B, a coefficient predictor 924 is used to generate an estimated coefficient value, c′ₙ₊₁. The coefficient predictor 924 use a number, m, coefficient values 922, which can be actual or estimated coefficient values, to predict the coefficient, c′ₙ₊₁, value 926. The estimated coefficient value 926 is input along with an actual value of the coefficient 928 to an adder 930 to generate a prediction error 932. As in FIG. 9A, a quantizer 912 may be used to generate a reduced-bit prediction value, e′ₙ₊₁, which is output and stored in the memory 704.

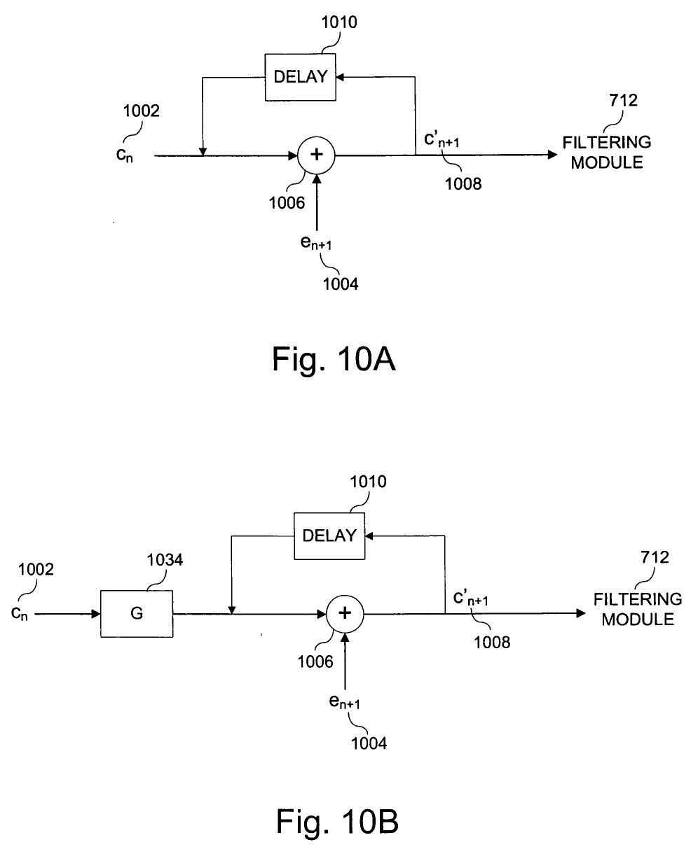

FIG. 10, which comprises FIGS. 10A and 10B, provides a component diagram which illustrates decompression performed by a MIMO processing module, e.g., interface 718, in accordance with one or more disclosed embodiments. Referring to FIG. 10A, to generate an estimated coefficient value 1008, a value of a previous actual or estimated coefficient 1002 is input to the adder 1006, together with a prediction value corresponding to coefficient value 1008. As can be seen, the output of the adder 1006, estimated coefficient value 1008, is input to the filtering module 712 and becomes coefficient value 1002 via delay 1010.

Referring to FIG. 10B, a block diagram similar to that shown in FIG. 10 is presented. In FIG. 10B, however, a filter 1034 operates on the sequence of actual or estimated coefficient values prior to its input to the adder 1006, in this example.

Numerous possible architectures for implementing the MIMO functionality to accompany a set of transceivers is possible and contemplated. It is currently common practice to implement a transceiver system onto one or more silicon chips comprising hardware processing units, memory, programmable processors, analog front end units etc. In many instances, it is common to have more than one transceiver units (or ports) implemented onto a silicon chip, e.g., quad or octal chips which contain four or eight individual transceivers.

It may be reasonable to consider adding MIMO functionality to a multiport transceiver chip by augmenting the design with a MIMO processing engine, which processes the signals from all transceiver ports of the multiport chip. This processing engine processes the signals at the appropriate stage of the signal processing chain, as shown functionally in FIG. 3 and FIG. 4, and may be implemented following one of the multiple embodiments presented herein.

Implementing the MIMO processing engine on the transceiver chip may be straightforward. In such a design, the size of the MIMO processing group is matched to the maximum number of transceivers supported on a single chip. Furthermore, the transceiver chip is configured with the additional complexity regardless of whether the MIMO functionality for a given application and for a particular manufacturer's overall system design.

A separate chip implementation is also available. If the MIMO engine is implemented in a separate chip, it can be utilized as an add-on coprocessor chip, and only included in the system if the MIMO functionality is required. Furthermore, if a MIMO group size is required that exceeds the number of ports in a multiport transceiver chip, the MIMO coprocessor can be designed to operate in conjunction with two or more multiport transceiver chips. This in turn raises the issue of how the MIMO coprocessor will exchange information with those transceiver chip, which is discussed in more details below.

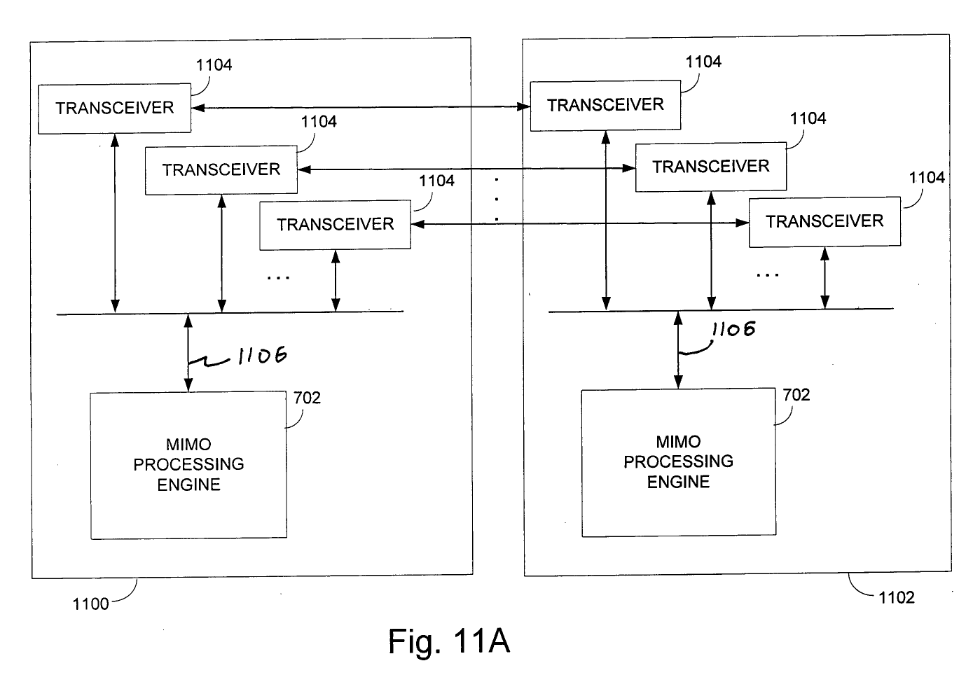

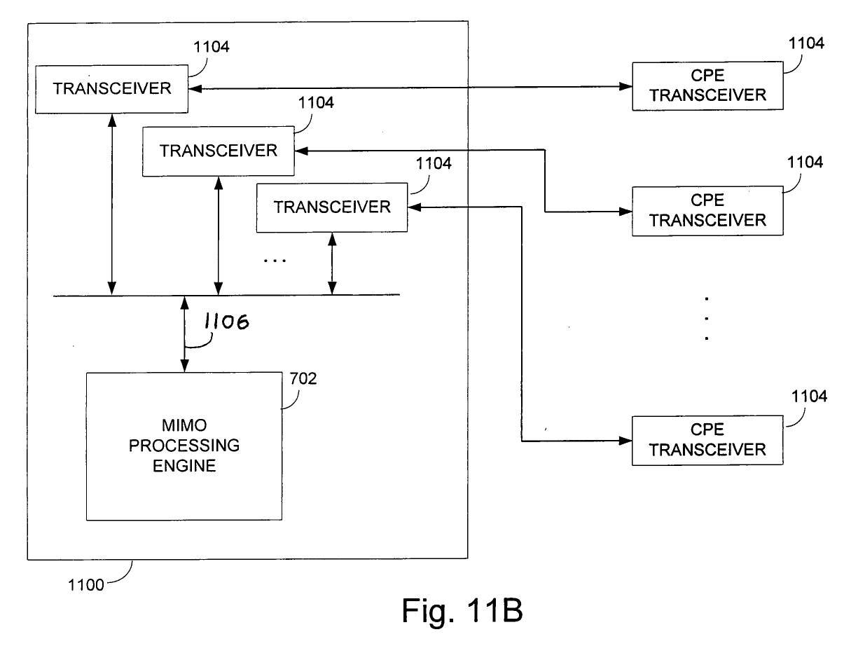

FIG. 11, which comprises FIGS. 1A and 1B, provides an example of multiple single pair transceiver chips 1104, coupled to a MIMO processing engine 702 in accordance with one or more disclosed embodiments. In the example of FIG. 11A, a point-to-point multi-channel communication link is shown between a central office (CO) 1100 and customer premises equipment (CPE) 1102. In a wireline application, for example, this link can represent a copper Ethernet or DSL link over multiple copper pairs. In such a case, a high speed data stream is partitioned across multiple channels (copper pairs) for transmission, and reassembled at another node into its original form, for example. In a wireless application, the components shown can depict an N-transmit-by-N-receive multi-antenna system.

By way of a further non-limiting example, the link can comprise two modems, the CO 1100 or base station modem/transceiver and the remote equipment, or CPE 1102. The CO 1100 as well as the CPE transceivers 1104 have several signal processing blocks that are dedicated to each channel, with each transceiver comprising various components e.g., AFE, line amplifiers, equalizers, etc. The transceivers 1104 are coupled to MIMO processing engine 702 via a high-speed bus 1106, and a control interface (not shown). In accordance with at least one embodiment, the MIMO processing engine 702 processes data across all of the individual channels, as shown. The MIMO signal processing performed by MIMO engine 702 can be implemented in the transmitter signal chain, the receiver signal chain, or in both.

With reference to FIG. 11B, the MIMO-enabled transceiver of FIG. 11A is generalized for point-to-multipoint applications. In FIG. 11B, all channels terminate at the same transceiver 1104 at the CO 1100, and at CPE side each channel services a different customer. In the example shown, MIMO processing can be performed in the upstream direction (CPE to CO) on the receiver side, and MIMO processing in the downstream direction (CO to CPE) can be performed at the transmitter side.

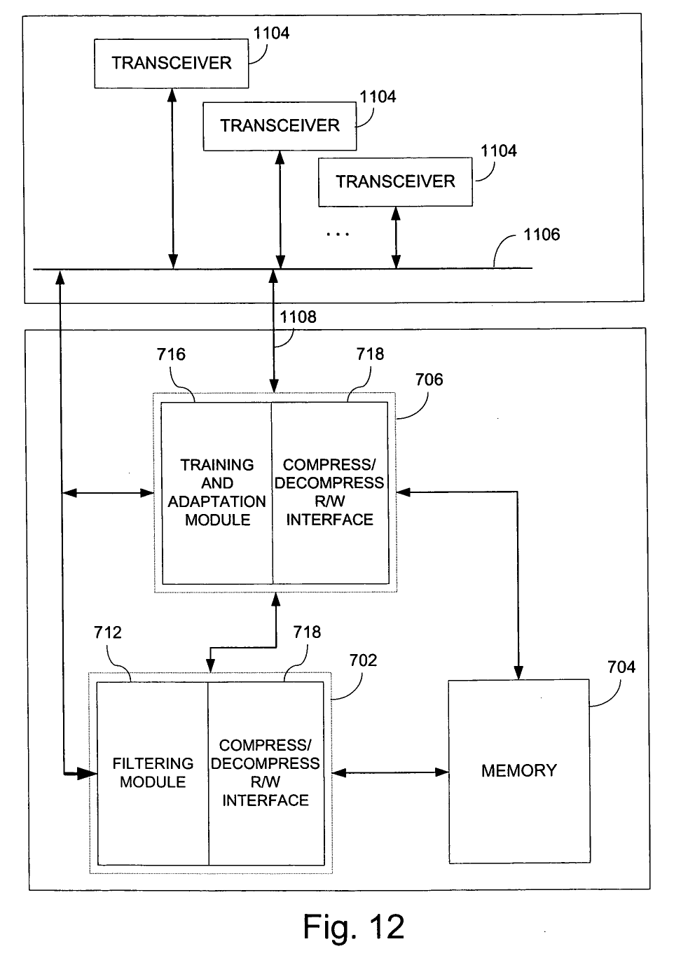

FIG. 12 provides an example of a MIMO processing engine coupled to a chip comprising multiple transceivers (multiport transceiver chip) in accordance with one or more disclosed embodiments. A high-speed data interface 1106 can be used to communicate signals from channel input to the filtering subsystem 702, or the training and adaptation subsystem 706, or both. In addition, a control interface 1108 is shown and allows control information to be exchanged between the training and adaptation subsystem 706 and one or more of the transceivers 1104 via bus 1106.

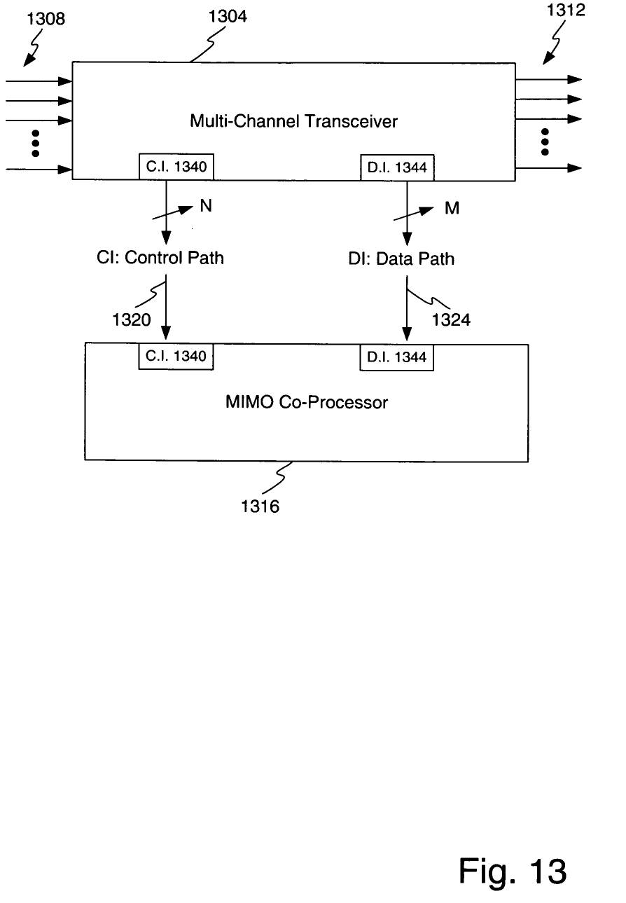

FIG. 13 illustrates a block diagram of multi-port transceiver chip connected to a MIMO co-processor chip. As shown, a multi-channel transceiver 1304 connects to multiple input channels 1308 connected to an analog front end chip (not shown) and multiple output channels 1312 connected to other data processing devices like switches etc (not shown). Any number of channels may be implemented. The transceiver may comprise any type transceiver capable of receiving and/or transmitting one or more signals over the channels 1308, 1312. In one embodiment the transceiver 1304 comprises one or more transceivers configured in accordance with a digital subscriber line (DSL) standard.

In communication with the transceiver 1304 is a MIMO co-processor 1316. The co-processor may comprise any type processor, controller, ASIC, control logic, state machine, or any other type device capable of performing the processing and calculations as set forth herein. The co-processor 1316 may comprise dedicated hardware or be configured to execute machine readable code. The machine readable code may be stored in a memory (not shown) in the co-processor 1316 or configured as a separate element from the co-processor. In one embodiment the co-processor 1316 is configured to perform MIMO processing received data.

Connecting the transceiver 1304 and the MIMO co-processor 1316 is a control path 1320 and a data path 1324. The paths 1320, 1324 may comprise any type communication path, such as metallic conductor or traces, or any other means for exchanging control information or data. The paths 1320, 1324 may comprise identical or different type conductive paths. Path 1320 comprises N number of paths while path 1324 comprise M number of paths, where N and M comprise any whole number and the values for N and M may be identical or different. In one embodiment, the number of data paths is greater than the number of control paths.

The control path 1320 connects to the transceiver 1304 and the co-processor 1316 via control interfaces 1340 as shown. The data path 1324 connects to the transceiver 1304 and the co-processor 1316 via data interfaces 1344 as shown. The interfaces 1340, 1344 may comprise any type interface capable of accurately exchanging data between two elements over a conductive path.

In operation, the channels 1308 carry multiple digital signals to the transceiver 1304. The transceiver 1304 performs signal processing on the incoming signals via a succession of signal processing blocks, as explained in FIGS. 3 and 4. As part of this processing, MIMO processing occurs to cancel unwanted crosstalk across the channels 1308 which couples into the signals on the channels. In FIGS. 3 and 4 the MIMO processing block is shown as a functional block, part of the overall signal chain. In this embodiment however, this block is implemented as an external coprocessor chip, while the remaining signal processing blocks are implemented in one or more transceiver chips. The data coming in and out of the MIMO block therefore, have to be routed in and out of the co-processor chip through the data interfaces 1344 over the data path 1324. The co-processor 1316 performs MIMO processing on the data to create processed data, and thereafter, returns the processed data to the transceiver.

In reference to FIG. 13, in one embodiment, it is contemplated that the architecture and interface requirements may be utilized to complementing a VDSL2 multi-port transceiver and be configured to utilize an external MIMO co-processor. In this example discussion, it is desirable that the architecture supports both TX MIMO processing and RX MIMO processing, although in other embodiments, only one may be utilized. In this discussion, only general system aspects are discussed, and detailed implementation specifications, such as bus timing, are outside the scope of this discussion and the claims that follow.

FIG. 13 shows a high level architecture diagram, where two interfaces are present between the transceiver block and the MIMO block. In this example discussion, the DI (Data Interface and data path) is a high rate, DMT symbol synchronous interface that makes the MIMO block part of the signal chain. In contrast, the CI (Control Interface and control path) is a real time or non real-time interface of lower rate, meant to provide control information (monitoring and configuration parameters) between the transceiver host and the MIMO block host. Both interfaces and paths may support different messages or information parameters.

As part of the MIMO processing, one or more various types of information are exchanged over the control interface 1340 and control path 1320. The types of data that may be exchanged over the control path 1320 facilitate the interoperation of the two devices. For example, in one embodiment the MIMO subsystem requires knowledge of the state of each pair, i.e., whether that pair is in data mode, or is in training mode, or is disconnected or in other state. This information may be provided by the control interface 1340. Furthermore, the MIMO subsystem may require knowledge of certain modulation parameters, like the number of bits transmitted per carrier and whether that carrier is active on not. It also may require knowledge of the exact power transmitted on each carrier (also known as fine gain per carrier) to appropriately adjust the MIMO filtering parameters. The control path 1320 provides means for the co-processor 1316 to obtain such information from the transceiver to thereby improve MIMO co-processing. Absent the interface 1340 and path 1320, the MIMO processing may occur in a sub-optimal manner.

Another important function of the control interface is to ensure that both devices (the MIMO coprocessor and the one or more transceivers) act in a synchronous manner. For example, if the transceiver device takes a pair out of service at a particular time t₀, the MIMO coprocessor should also remove that pair from the MIMO filtering operation at precisely the same time t₀. Similarly, if a new pair is added to the system it has to be done with caution in order to not interfere with the existing pairs. U.S. patent applications having Ser. Nos. 10/913,705 and 10/913,285 incorporated herein in their entirety by reference teach that a newly added pair may be added at low power in the beginning, giving time to the MIMO subsystem to adapt to the new interference pattern, then increase to a high or normal power mode. The switching or slow transition from low power to high power at a given time t₀ may preferably happen simultaneously in both devices.

Another example where synchronous action may be required is when the Tx power allocation may need to change across the transmit carriers (change in the carrier fine gains) due to changes in the noise environment, temperature etc. In this case as well, both devices may have to simultaneously change the Tx power allocation and the MIMO filtering coefficients respectively.

In order to achieve synchronicity, both devices have to maintain a common time reference (e.g., matching transmitted or received symbol counters). Furthermore, whenever the transceiver initiates an event that requires synchronous operation (like for example, pair add, pair drop, or power changes), it has to notify the MIMO coprocessor well in advance, so that the coprocessor device may prepare for the change. The control interface should preferably therefore support two main functions: (i) the means for the two devices to initialize their symbol counters at the same time and thus achieve a common time reference, and (ii) the means for providing advance warning to the other device for upcoming events that require synchronous operation.

Joint initialization of symbol counters requires some type of real-time signaling between the devices, such as interrupt signaling or other hardware or software or real-time message based signaling. For advance notification of important events, a non-real time, but more complicated procedure is involved.

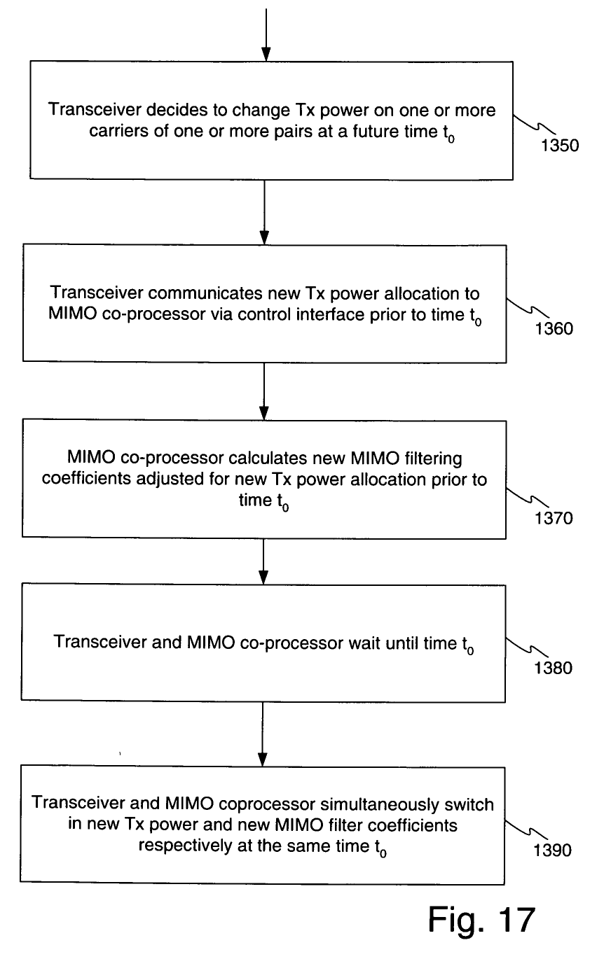

In FIG. 17 a sequence of steps is presented for achieving synchronous operation in the example of reallocation of power across the transmit carriers. This is but one possible example method of operation and as such, other methods may be enabled which do not depart from the claims which follow. At step 1350 the transceiver decides to change the transmit power (by modifying the carrier fine gains) on at least one carrier of at least one pair and earmarks a specific time point in the future to, when this operation will occur. At step 1360, the transceiver communicates this future time point to the MIMO coprocessor over the control interface, along with other possible required information, such as but not limited to, type of action to be performed at to, (Tx power reallocation in this example), the identity of the carriers affected, the new power and/or bits carried by those carrier etc. At step 1370, the MIMO coprocessor calculates the new MIMO filtering coefficients, required for the new Tx power. Then, both the transceiver and the MIMO coprocessor await for the arrival of time t₀, at step 1380. Finally, at step 1390, both devices switch simultaneously to the new Tx power and new MIMO coefficients respectively.

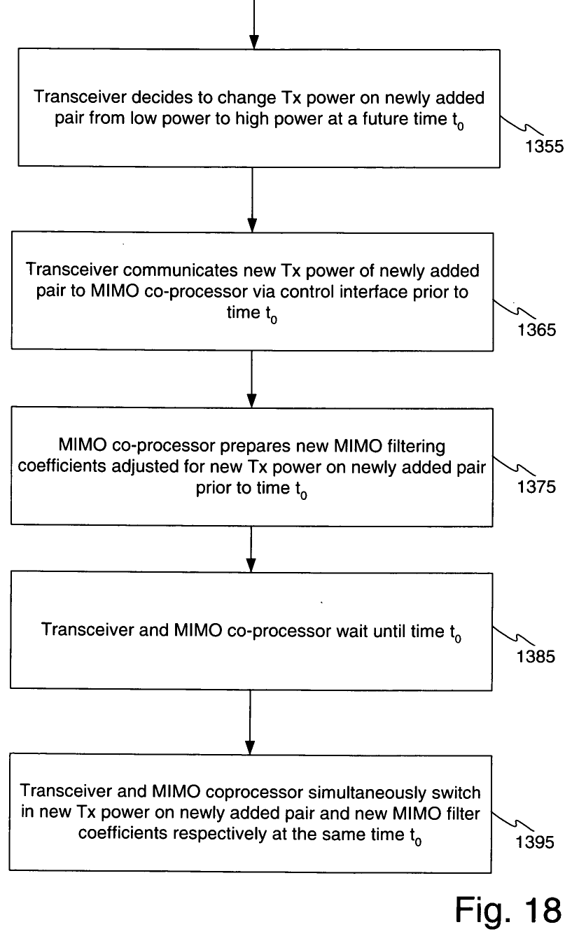

In FIG. 18 is an exemplary flow diagram of a sequence of steps for achieving synchronous operation in the another example of switching a newly added line from a low power state to a high or normal power state. At step 1355 the transceiver decides to change the transmit power mode of at least one newly added pair and earmarks a specific time point in the future to, when this operation will occur. At 1365, the transceiver communicates this future time point to the MIMO coprocessor over the control interface, along with other required information, such as but not limited to type of action to be performed at to, (power mode change in this example), the identity of the pairs affected, the new power and/or bits per carrier of the affected pair(s) etc. At step 1375, the MIMO coprocessor calculates the new MIMO filtering coefficients, required for the new environment which includes the newly added pair. Then, both the transceiver and the MIMO coprocessor await for the arrival of time t₀, at step 1385. Finally, at step 1395, both devices switch simultaneously to the new Tx power mode and new MIMO coefficients respectively.

It is contemplated that control data sent to or coordinated between the MIMO filter and the transmitter (or receiver) may also include a pair activation status. Pair activation status comprises information regarding the status of a pair or the activation or deactivation of pairs, or transmit power level for one or more pairs.

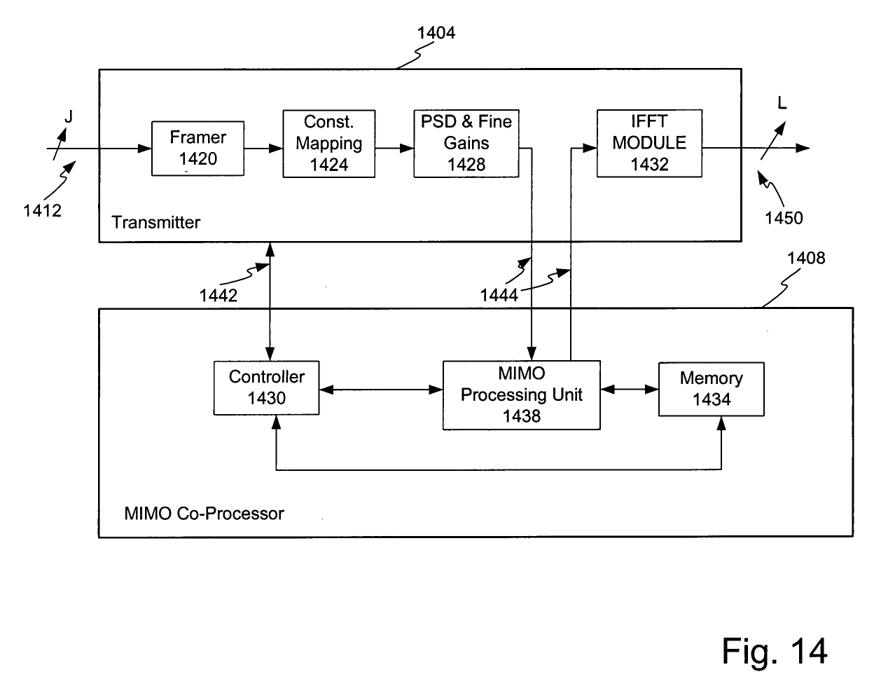

FIG. 14 illustrates a detailed block diagram of a transmitter with MIMO co-processor. In this example embodiment certain elements are omitted to aid in understanding and to focus on the more relevant aspects of operation. In this embodiment, a transmitter device 1404 is provided to perform transmit processing on the outgoing signals. The transmitter operates in connection with a co-processor configured to perform MIMO type pre-processing on the outgoing signals.

Outgoing signals are provided on input channel(s) 1412 having J number of channels, where J may comprise any whole number of channels. The channel(s) 1412 carry information bits to be transmitted and may comprise any type channel including metallic conductors, optic paths or any other type channel(s) capable of carrying outgoing signals for transmission by the transmitter device 1404.

In this example embodiment the transmitter 1404 comprises a framer 1420, a constellation mapping module 1424, a power spectral density (PSD) and fine gains shaping module 1428 and an inverse Fourier transform unit 1432. These elements are connected as shown in FIG. 14. The framer 1424 is configured to assemble the outgoing date into protocol units of data. The units may comprise frames, packets, or other units according to the communication protocol in use and such frames may include synchronization bits added to aid in reception or parsing of the data. Framing is generally understood by one of ordinary skill in the art of DSL communication systems.

After framing, the data is processed by the constellation mapping module 1424. The mapping module 1424 processes the outgoing data to translate the data into bins. The mapping may include translation of the bits into the various bins which comprise the available bandwidth. The mapping module may also translate the data in complex format to a grid of points, such as binary data, or from binary data to complex values. In general, operation of constellation shaping and mapping is understood in the art and as such, is not described in detail herein. Bit extraction may occur as part of the mapping on the data frames.

After constellation mapping, in module 1424, the data is subject to power spectral density and fine gains shaping. In one embodiment, such power and gain shaping is based on a bits and gain table established by the transmitter and receiver during a training phase, and this table may be updated or modified during operation. Spectral shaping may also occur to reduce spectral power content at certain frequencies to thereby maintain operation within the applicable standard. In one embodiment, the complex data value representing the constellation point for each carrier is multiplied by a gain that is associated with each carrier.

After processing by element 1428, the signal chain is interrupted and the data is routed to the MIMO co-processor 1408. It is contemplated that the co-processor 1408 is a separate element from the transmitter 1404 and as such may be located in a separate integrated circuit, or in a different section of the same integrated circuit, or in some manner separate from the transmitter. It is contemplated that in one embodiment, the transmitter 1404 may be modified or utilized in applications separate from use with the MIMO co-processor 1408.

In this example embodiment, the data from the transmitter 1404 is routed to the MIMO processing unit 1438. The MIMO processing unit 1438 may comprise a processor, ASIC, DSP, controller, or dedicated hardware processing unit configured to perform MIMO processing on the data from the transmitter 1404. One example embodiment of the MIMO processing unit 1438 is described below in more detail.

The MIMO processing unit 1438 is in communication with a memory 1434 and a and a controller 1430. The memory 1434 may comprise any type memory currently in use or developed in the future. The memory 1434 may be utilized to store filter coefficients, such as those used in the MIMO processing unit 1438, or gain values, slicer values, or any other value as described herein or otherwise.

The controller 1434 is configured to coordinate operation of the MIMO processing unit 1438 and the memory 1430 in connection with the transmitter 1404. The controller 1430 may oversee input and output of data between the transmitter 1404 and the MIMO co-processor 1408. In one embodiment the controller 1430 includes a control data interface. In one embodiment the controller 1430 comprises a processor or other processing element. The controller 1430 is also in communication with the transmitter 1404 to provide means for exchange of information, with the transmitter, such as sync symbol timing, filter coefficients, gains, fine gains, bit loading tables, pair activation state or any other data, to assist in the proper operation of the MIMO subsystem as explained in detail in the examples of FIGS. 17 and 18.

It is further contemplated that the memory 1434, MIMO processing unit 1438 and controller 1430 and may also comprise the elements and capability as shown and set forth above in connection with FIGS. 7-12. As such, the coefficients used by the filter of the MIMO processing unit 1438 may be generated based on compressed values or delta values (changes) between coefficients across bins.

After MIMO processing, the processed values are sent to the IFFT module 1432 in the transmitter 1404. The IFFT module 1432 comprises a inverse fast Fourier transform unit configured to convert complex values to real values suitable for transmission over the channel in accordance with the communication standard described herein. As would be understood, other processing standard may be adopted for use and would utilized other transmitter elements. Additional processing may occur, including prefixing and windowing, digital to analog conversion and amplification for driving the signal over the channels 1450, etc. L number of channels 1450 may be utilized, where L comprises any whole number. In one embodiment, L comprises twisted pair type conductors.

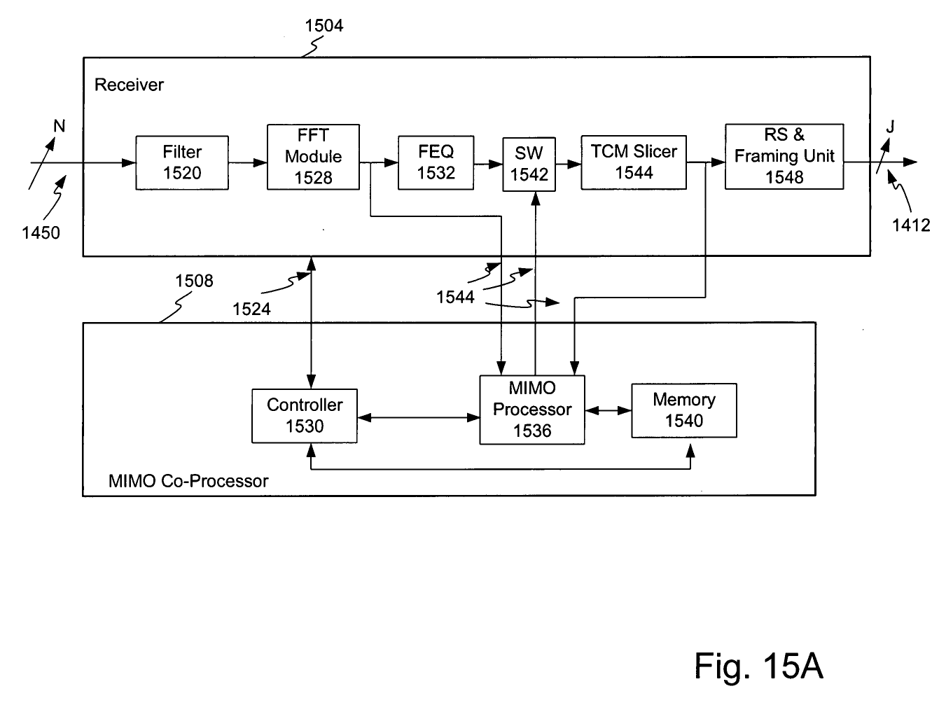

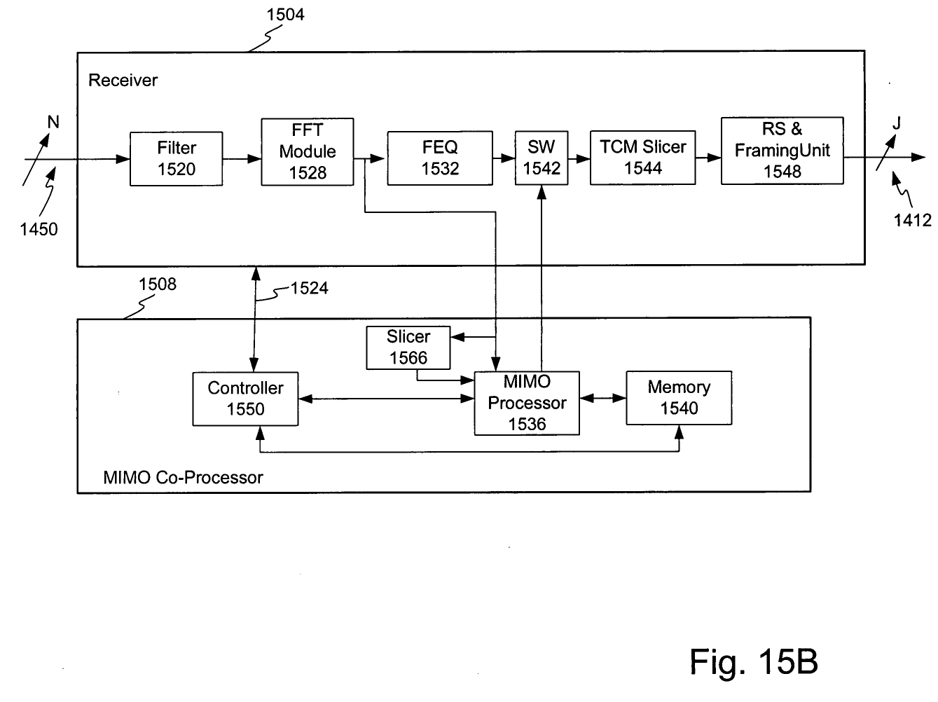

FIG. 15A illustrates an exemplary block diagram of a receiver configured to interface with a MIMO co-processor. In this example, embodiment, the channel(s) 1450 having L number of lines, where L is any whole number, connects to the receiver 1540. Upon receipt the incoming signals may be processed by an analog front end (not shown). As with other figures, certain elements are omitted so that focus may be on the elements which best enable understanding of the invention. After processing by the analog front end and other option processing, the one or more of the incoming data is provided to a filter 1520. The filter 1520 may comprise any type filter or equalizer and may be digital or analog in nature. In one embodiment the filter comprises a feed forward equalizer configured to reduce channel dispersion and shorten the channel impulse response

The control interface 1524 may comprise any arrangement of hardware, software, or both configured to received and process control data received as part of the signal on channels 1450 or control data received on one or more other channels or generated by the receiver's control logic. Examples of control data includes, but is not limited to gains and fine gains information, bit loading information, channel timing and framing data, sync symbol timing, and pair status information, or any other control parameter utilized to enable or improve operation of the receiver 1504, MIMO coprocessor 1508, or both.

After filtering by the filter 1520, the data is presented to a fast Fourier transform (FFT) module 1528, which is configured to perform a Fourier transform operation on the data to translate the data into the complex or frequency domain. The output of the FFT module 1528 is routed to the MIMO co-processor 1508 and in particular to the MIMO processor 1536. A data interface 1544 as described above may facilitate input and output of the data between the receiver 1504 and the MIMO co-processor 1508. The MIMO processor 1536 performs MIMO processing, often referred to a MIMO filtering, on the data. A memory 1540 is provided as part of the MIMO co-processor 1508 and is read-writable by the MIMO processor 1536. As described herein, the memory 1540 may store any type data utilized to enable or optimize operation of the co-processor 1508. A controller 1530 is also part of the MIMO subsystem similar to the configuration of FIG. 14. In this embodiment, the controller exchanges control information with the transceiver 1504 and is responsible for configuring, training and adapting the MIMO processing unit of 1536.

In this embodiment, the MIMO co-processor 1536 may also optionally receive the output from a slicer 1544. The slicer output may be utilized by the MIMO co-processor 1508 during operation to generate an error term, between the output of the MIMO processed data and the data values output from the slicer 1544. This error term may be utilized by the MIMO processor 1536, to cancel crosstalk noise in other lines and further improve the performance of the system. Such MIMO systems may be known to those skilled in the art as decision feedback MIMO architectures.

The output from the MIMO processor 1536, which comprises the filtered data, is returned to the receiver 1504 as shown. In this example embodiment the filtered data is returned to a switch 1542 in the receiver 1504. The switch also receives the output from a FEQ 1532. The FEQ comprises a frequency based equalizer configured to equalize the magnitude and phase of each received carrier to a predetermined value. The switch 1542 may selectively output to the slicer 1544 either the output from the MIMO processor 1536 or the output from the FEQ 1532.

In certain instances it is contemplated that it may be desired to not utilized the MIMO processing capability from the co-processor 1508, for reasons of reduced complexity or cost or PCB board space limitations or power consumption or other limitations. In that case the co-processor 1508 is not present in the design and the switch 1542 selects the FEQ output for further processing.

After slicing by the slicer 1544, the filtered data is provided to the RS and framing unit 1548. In this embodiment, the RS and framing unit 1548 restores the data to data frame format based on Reed-Solomon type coding and decoding. In other embodiments, other types of coding/decoding may be utilized to improve the data rate, decrease the bit error rate, or both. The resulting bit stream data is output from the receiver on output 1412 having J number of conductors or paths, where J equals any whole number.

In operation, data is received via inputs 1450 and processed in a manner generally understood in the art for a DMT type communication system by the receiver 1504. After initial processing, the data is set to an separate MIMO co-processor 1508 via one or more conductors as shown. The MIMO processor 1536 performs multiple input, multiple output processing on the data. After processing, the data is returned to the receiver 1504 for additional processing and eventual output to the next layer or application in the processing path.

In other embodiments, variations of this architecture may be involved. For example, the data provided to the MIMO coprocessor may be tapped off the signal chain at the output of the FEQ block 1544 as opposed to the input shown in FIG. 15A. Other variations may also be possible without altering the basic nature of the current invention.

FIG. 15B illustrates an exemplary block diagram of a receiver configured to a MIMO co-processor without slicer output feedback to the MIMO co-processor. As compared to FIG. 15A, identical or similar elements are referenced with identical reference numbers. Due to duplication of certain aspects between FIGS. 15A and 15B, only the aspects of FIG. 15B which differ from those of FIG. 15A are discussed. In addition, this is but one possible embodiment and as such it is contemplated that other embodiments may be enabled or claimed based on the description contained herein.

In FIG. 15B, the controller interface 1524 connects to a controller 1550 which is configured to receive the control data or control information from the receiver 1504. The control data may comprise any type control data discussed herein or any other type of control data utilized to achieve or optimize the MIMO filtering operation. By providing the control data via an interface 1524 and controller 1550, relevant information may be exchanged between the receiver 1504 and the co-processor 1508 to enable or optimize operation of a separate MIMO processing element. This provides the benefits described herein and overcomes many of the drawbacks of the prior art.

The controller 1550 communicates with the MIMO processor 1536 and the memory 1540 as shown. Via this connection the control data may be provided to the processor 1536 and memory 1540 so that relevant control data is available for use by the co-processor 158.

Also part of the co-processor 1508 in this example embodiment is a slicer 1566, which is configured to receive and process the data from the receiver 1504 to generate a quantized output value representative of the sliced data. In this embodiment, the slicer 1566 is built into the co-processor 1508 instead of being located in the receiver 1504. Although duplicate slicers may thus be required, fewer data and control interface connections may be required, since the slicer output is generated internal to the co-processor 1508 and not received from the receiver 1504. This arrangement may reduce complexity of the interface, including synchronization, and the number interconnects between the receiver and the co-processor.

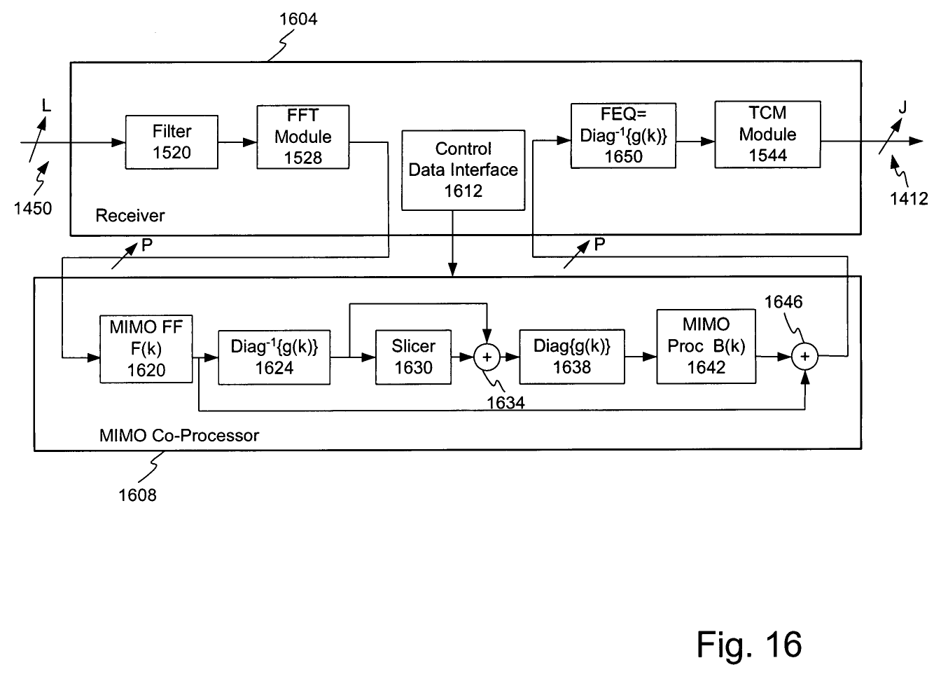

FIG. 16 illustrates a more detailed block diagram of a receiver and co-processor arrangement. In particular it depicts how the various stages of the MIMO filtering architecture are affected by the actual values of the fine gains g(k) of each carrier for each pair. Each block of FIG. 16 is first discussed and then the mathematical justification for this design is provided.

Although shown in more detail, certain aspects of the system are omitted to aid in understanding of the invention. As compared to FIG. 15A, identical or similar elements are referenced with identical reference numbers and not discussed in detail. In this embodiment, the components of the co-processor 1608 are expanded in detail. As described above, a control data interface 1612 provides control data to the co-processor 1608.

Likewise, the data input from the receiver 1604 is routed to a feedforward matrix filter 1620 in the separate co-processor 1608. Any number of P conductors or paths, where P represents any whole number, may be utilized for data exchange between the receiver 1604 and the co-processor 1608. In one embodiment the filter 1620 comprises a feed forward filter (FFE) configured to remove FEXT crosstalk from other lines.

After filtering, the data is subject to processing in multiplier 1624 defined as diag⁻¹{g(k)} which may be considered as the inverse of the diagonal matrix containing the fine gains for all pairs for carrier k, which may correct for differences in fine gains. Thereafter, the data undergoes a slicer operation, by a slicer 1630 to generate a quantized output representing the data value at the time of slicing. The slicer output is combined in junction 1634, in a manner which with yield the error term, which is the difference between the quantized value and the input to the slicer 1630. This value is provided to a multiplier 1638 defined as diag{g(k)} which is configured to perform diagonal processing which is the inverse of that performed in element 1624. In one embodiment, the processing by element 1638 performs scaling of the data based on the gains.

The output of element 1638 is routed to the feedback MIMO processing unit 1642, wherein decision feedback MIMO processing occurs to filter its multiple input signals to yield multiple output signals which have reduced crosstalk interference. The output of the MIMO processing module 1642 is provided to junction 1646, which combines the MIMO unit output with the output from the filter 1620. The output of the junction 1646 yields the MIMO compensated signals to be routed back into the transceiver.

The output from the junction 1646 is routed back to the receiver, and in particular to a frequency equalizer 1650, configured as diag⁻¹{g(k)} this is done to establish desired scaling on the values back to a level suitable for further processing. The output of the FEQ 1650 connects to the TCM (trellis code modulation) module 1544 to reverse the effects of trellis encoding on the signal. Thereafter, the data is output from the receiver on the output path 1412 having J number of paths, where J is any whole number.

The following discussion provides a more detailed description of the theory of operation and modeling for the various embodiments shown in the figures. Although presented at a higher level of complexity, it is submitted that one of ordinary skill in the art will understand the math and theory presented below. Certain steps and discussion has been omitted as appropriate from this high level discussion.

### System Model

A frequency domain system model will be useful in the following developments. Let

$$s ( k ) = [ \begin{matrix}{s}_{1} ( k ) \\ ⋮ \\ {s}_{L} ( k )\end{matrix} ]$$

be the vector of constellation points for bin k before gain scaling and IFFT, where L is the number of lines in the MIMO group. Let

$$g ( k ) = [ \begin{matrix}{g}_{1} ( k ) \\ ⋮ \\ {g}_{L} ( k )\end{matrix} ]$$

be the vector of Tx gains (including fine gains and PSD shaping gains) that is applied to s(k) before IFFT.

Then the scaled constellation vector is given by diag{g(k)}s(k), where

$$diag \{ g ( k ) \} = [ \begin{matrix}{g}_{1} ( k ) & & 0 \\ & ⋰ & \\ 0 & & {g}_{L} ( k )\end{matrix} ]$$

The channel can modeled in the frequency domain (from the input of the IFFT to the output of the receive FFT) with an L×L matrix

$$H ( k ) = [ \begin{matrix}{h}_{11} ( k ) & ⋯ & {h}_{1 L} \\ ⋮ & ⋰ & ⋮ \\ {h}_{L 1} & ⋯ & {h}_{LL} ( k )\end{matrix} ]$$

Then the received signal at the FFT output is

x(k)=H(k)diag{g(k)}s(k)+v(k)

where v(k) represents additive noise (including crosstalk).

### TX MIMO Case

FIG. 14 shows some more details of the transmitter block and indicates how the MIMO block 1438 can be interjected into the signal chain. The input to the MIMO block may consist of sets of bin values for all vectored lines. Similarly, the MIMO processed bin values are returned back to the IFFT module 1432.

A linear zero forcing MIMO architecture is sufficient for FEXT pre-compensation. Then, the MIMO effect on the signal chain can be modeled by a processing matrix F(k) applied after the gain scaling. Then the signal model becomes

x(k)=H(k)F(k)diag{g(k)}s(k)+v(k)

If F(k) is chosen as

F(k)=H⁻¹(k)diag{H(k)}

where

$$diag \{ H ( k ) \} = [ \begin{matrix}{h}_{11} ( k ) & ⋯ & 0 \\ ⋮ & ⋰ & ⋮ \\ 0 & ⋯ & {h}_{LL} ( k )\end{matrix} ]$$

then crosstalk is eliminated and the end-to-end model becomes

x(k)=diag{H(k)}diag{g(k)}s(k)+v(k)

Processing at the receiver is completed by applying the FEQ (and gain) equalizer

\check{s}(k)=diag⁻¹{g(k)}diag⁻¹{H(k)}x(k)

and slicing the resulting constellation points.

It is contemplated that the MIMO solution does not depend on the fine gains in this case. The MIMO engine does not need to be aware of the bits and gains table of the transmitter.

Training and adaptation of the MIMO matrix is based upon estimates of all the entries of the channel matrix. This in turn is estimated at the CPE based on sync symbol orthogonal training sequences. This channel information should be part of the control interface.

### RX MIMO Case

In the Rx MIMO case, MIMO processing may be applied at the output of the FFT. FIG. 15A, 15B shows a block diagram of the Rx MIMO coprocessor concept with the data interface to the transceiver.

### Feedforward Architecture and Zero Forcing

In the frequency domain model, F(k) multiplies the signal after the channel

\check{s}(k)=F(k)x(k)=F(k)H(k)diag{g(k)}s(k)+F(k)v(k)

If there is no concern for alien disturbers, a simple channel inverse solution will suffice (zero forcing architecture) followed by the inversion of the transmitter gains

F(k)=diag⁻¹{g(k)}H⁻¹(k)

By plugging F(k) into the model equation, it can be shown that that this solution eliminates self-crosstalk and FEQ equalizes each channel.

The inversion of the fine gains can be part of the MIMO matrix F(k) as in the equation above or can be a separate operation. That operation can be part of the MIMO coprocessor. Alternatively, the FEQ stage of the transceiver can be used to equalize the gains and the MIMO matrix F(k) be limited to the inversion of the gain normalized channel. This architecture is depicted in FIG. 15.

### MMSE Solution

The MMSE solution for the matrix F(k) is

$$\begin{matrix}F ( k ) = {R}_{sy} ( k ) {R}_{yy}^{- 1} ( k ) \\ = {σ}_{s}^{2} ( k ) diag \{ g ( k ) \} {H}^{H} ( k ) [ {σ}_{s}^{2} ( k ) H ( k ) diag \{ g ( k ) \} \\ { {diag}^{H} \{ g ( k ) \} {H}^{H} ( k ) + {R}_{vv} ( k ) ]}^{- 1}\end{matrix}$$

In this case the feedforward matrix F(k) depends on the transmitter fine gains in a complicated way (they influence the structure of the data covariance matrix). Therefore, when those gains change due to bit swapping, this matrix may need to be adapted.

However, full re-computation of the above F(k) expression at every bit swap may be computationally prohibitive. In order to obtain some more insight on the sensitivity of F(k) to the fine gains, we apply the matrix inversion lemma to the bracketed expression in the equation above. After some algebraic steps F(k) can be re-written as

F(k)=diag⁻¹{g(k)}H^{H}(k)[diag⁻¹{g(k)}diag^{-H}{g(k)}+σₛ²(k)H^{H}(k)Rᵥᵥ⁻¹(k)H(k)]⁻¹σₛ²(k)H^{H}(k)Rᵥᵥ⁻¹(k)

The gains now appear in the bracketed expression in a separate matrix term. The other matrix term in that bracket is much bigger than the gain term (the second term is of the order of the receive SNR while in this example, the gain term is of the order of 0 dB (plus/minus 2.5 dB) and in the receive band SNR >>0 dB. We can therefore approximate F(k) by substituting the gain term in the bracketed expression by the identity matrix (or omitting it all together)

$$\begin{matrix}F ( k ) \approx {diag}^{- 1} {\{ g ( k ) \} [ I + {σ}_{s}^{2} ( k ) {H}^{H} ( k ) {R}_{vv}^{- 1} ( k ) H ( k ) ]}^{- 1} \\ {σ}_{s}^{2} ( k ) {H}^{H} ( k ) {R}_{vv}^{- 1} ( k ) \\ = {diag}^{- 1} \{ g ( k ) \} {F}_{0} ( k )\end{matrix}$$

This simplified expression is very instructive because it shows that the feedforward operation can be decomposed into two stages: (i) the operation with the 0 dB gain normalized matrix F₀(k) followed by (ii) a stage that inverts the transmitter gains. Here as in the zero forcing case, the fine gain inversion can be accomplished by the transceiver FEQ stage. In other words, the architecture of 15 is still valid. It should also be noted that this MIMO solution does depend on the fine gains. If the output of the feedforward matrix is explicitly scaled however, the sensitivity of the system to the fine gains will be small and will be handled by adaptation.

Training and adaptation may require decision errors to guide the training process. In order to simplify the interface, the system can, in one embodiment, perform adaptation only during the sync symbol, which can be easily sliced in the DSP. Therefore this only requires notification from the transceiver, when the sync symbol occurs. With this exception, adaptation can be self contained in the MIMO co-processor chip.

### Feedforward-Feedback Architecture

A feedforward-feedback architecture has an additional feedback matrix operation in addition to the feedforward one discussed before. In this embodiment, the feedback matrix is triangular and operates on the slicer error. The slicer error may be obtained by passing the output of the feedforward operation through a slicer, given by the following equation:

e(k)=[F(k)x(k)−s(k)]

The combined MIMO noise compensation architecture model may be represented as:

$$\begin{matrix}{s}^{⋒} ( k ) = F ( k ) x ( k ) - B ( k ) e ( k ) \\ = F ( k ) x ( k ) - B ( k ) [ F ( k ) x ( k ) - s ( k ) ] \\ = [ I - B ( k ) ] [ F ( k ) x ( k ) - s ( k ) ]\end{matrix}$$

It can be shown that using the principle of orthogonality, that the MMSE solutions for the matrices F(k) and B(k) are de-coupled; that is, F(k) can be computed independently of B(k) as before

$$\begin{matrix}F ( k ) = {R}_{sy} ( k ) {R}_{yy}^{- 1} ( k ) \\ = {σ}_{s}^{2} ( k ) diag \{ g ( k ) \} {H}^{H} ( k ) [ {σ}_{s}^{2} ( k ) H ( k ) diag \{ g ( k ) \} \\ { {diag}^{H} \{ g ( k ) \} {H}^{H} ( k ) + {R}_{vv} ( k ) ]}^{- 1}\end{matrix}$$

The matrix [I−B(k)] is computed as the inverse Cholesky factor of the feedforward output error matrix

[I−B(k)]Rₑₑ(k)[I−B(k)]^{H}=D(k)

where

Rₑₑ(k)=E{[F(k)x(k)−s(k)][F(k)x(k)−s(k)]^{H}}

If the fine gains of the transmitter change, then the feedforward matrix may have to be compensated by the inverse of the fine gains. This was discussed above. This in turn will affect the covariance of the slicer error vector. Under the assumption that the slicer error is dominated by non-self FEXT noise (e.g., alien crosstalk or background noise), then the error covariance matrix can be directly scaled by the inverse gain scaling of the feedforward matrix

R ee(k)=diag⁻¹{g(k)} R̅ₑₑ(k)diag^{-H}{g(k)}

where R̅ₑₑ(k) denotes the covariance matrix of the normalized error (when fine gains are normalized to 0 dB).

It can be shown that the pre- and post-scaled feedback matrix as below

[I−B(k)]→diag⁻¹{g(k)}[I− B̅(k)]diag{g(k)}

where B̅(k) is the inverse Cholesky factor of the normalized covariance matrix R̅ₑₑ(k), diagonalizes the scaled covariance matrix Rₑₑ(k) to the scaled diagonal matrix

D(k)=diag⁻¹{g(k)} D̅(k)diag⁻¹{g(k)}

FIG. 16, discussed above in more detail, depicts the complete MIMO architecture, assuming that the slicer is duplicated in the MIMO coprocessor (for the benefit of simplifying the data interface to the transceiver). It is contemplated that in this system the Fine gain information (bits and gains) may be required in the MIMO coprocessor. This may be true for all architectures, as signal scaling is important for the adaptation process. Furthermore, tone ordering information is needed. Since the slicer is internal to the MIMO processor in this case, training and adaptation does not require additional external information.

While various embodiments of the invention have been described, it will be apparent to those of ordinary skill in the art that many more embodiments and implementations are possible that are within the scope of this invention.

What is claimed is:

1. A communication device comprising:
a transmitter comprising:
one or more inputs configured to receive data;
one or more transmitter data interfaces configured to output the data via one or more data paths;
one or more transmitter control interfaces configured to output control data via one or more control data paths;
one or more inputs configured to receive MIMO filtered data;
a transmitter subsystem configured to process the MIMO filtered data and transmit the processed MIMO filtered data;
a MIMO co-processor comprising:
one or more MIMO co-processor data interfaces configured to connect to the one or more data paths and receive data from the transmitter data interfaces;
one or more MIMO co-processor data interfaces configured to connect to the one or more control data paths to receive data form the transmitter control interfaces; and
a MIMO filter configured to received the data and processes the data based at least in part on the control data to create the MIMO filtered data.

2. The communication device of claim 1, wherein the MIMO co-processor further comprises a controller configured to process the control data to establish one or more MIMO filter settings.

3. The communication device of claim 2, wherein the one or more MIMO filter settings depend on one or more of the following: gains, fine gains, bit loading, pair activation status and sync symbol timing.

4. The communication device of claim 1, wherein MIMO co-processor is located on a separate integrated circuit from the transmitter.

5. A communication device comprising:
a transceiver comprising:
one or more inputs configured to receive data;
one or more transceiver data interfaces configured to output the data via one or more data paths;
one or more transceiver control interfaces configured to output control data via one or more control data paths;
one or more inputs configured to receive MIMO filtered data from a MIMO co-processor;
a MIMO co-processor comprising:
one or more MIMO co-processor data interfaces configured to connect to the one or more data paths and receive data from the transceiver data interfaces;
one or more MIMO co-processor control interfaces configured to connect to the one or more control data paths to receive control data form the transceiver control interfaces; and
a MIMO filter configured to receive the data and process the data based at least in part on the control data to create the MIMO filtered data.

6. The communication device of claim 5, wherein the MIMO co-processor further comprises a slicer.

7. The communication device of claim 5, wherein the MIMO co-processor is configured to receive slicer output values from the transceiver.

8. The communication device of claim 5, wherein the MIMO co-processor further comprises a memory configured to store MIMO filter coefficient values or MIMO filter coefficient value differentials.

9. The communication device of claim 5, wherein MIMO co-processor is located on a separate integrated circuit from the transceiver.

10. The communication device of claim 5, wherein the transceiver comprises a multi-channel communication device and the one or more inputs comprise one or more twisted pair conductors.

11. The communication device of claim 5, wherein the MIMO co-processor further comprises a controller configured to process the control data to establish one or more MIMO filter settings.

12. The communication device of claim 11, wherein the one or more MIMO filter settings depend on one or more of the following: gains, fine gains, bit loading, pair activation status and sync symbol timing.

13. A method for MIMO processing data in a multi-channel communication system comprising:
receiving data at a multi-channel transceiver;
processing the received data with the multi-channel transceiver to create processed data;
generating control data;
outputting the control data to a separate MIMO co-processor;
outputting the processed data to the separate MIMO co-processor;
filtering the processed data with the separate MIMO co-processor to create filtered data, wherein the filtering is based on the control data;
outputting the filtered data to the multi-channel transceiver.

14. The method of claim 13, wherein processing the received data with the multi-channel transceiver comprises performing DMT type processing.

15. The method of claim 13, wherein the control data comprises gains, fine gains, bit loading, pair activation status and sync symbol timing.

16. The method of claim 13, further comprising calculating slicer output values or an error term within the separate MIMO co-processor.

17. The method of claim 13, wherein outputting the control data and processed data to a separate MIMO co-processor comprises outputting to a MIMO co-processor on a separate integrated circuit.

18. A communication device comprising:
a receiver comprising:
one or more inputs configured to receive data;
one or more receiver data interfaces configured to output the data via one or more data paths;
one or more receiver control interfaces configured to output control data via one or more control data paths;
one or more inputs configured to receive MIMO filtered data;
a receiver subsystem configured to process the MIMO filtered data to create processed MIMO filtered data and output the processed MIMO filtered data from the receiver;
a MIMO co-processor comprising:
one or more MIMO co-processor data interfaces configured to connect to the one or more data paths and receive data from the receiver data interfaces;
one or more MIMO co-processor data interfaces configured to connect to the one or more control data paths to receive data form the receiver control interfaces; and
a MIMO filter configured to received the data and processes the data based at least in part on the control data to create the MIMO filtered data.

19. The communication device of claim 18, wherein the MIMO co-processor further comprises a controller configured to process the control data to establish one or more MIMO filter settings.

20. The communication device of claim 19, wherein the one or more MIMO filter settings depend on one or more of the following: gains, fine gains, bit loading, pair activation status and sync symbol timing.

21. The communication device of claim 18, wherein MIMO co-processor is located on a separate integrated circuit from the receiver.

22. A method for executing a transmit power change on a multi-channel transmitter which utilizes a MIMO co-processor comprising:
processing a request to change a transmit power level defined by a new transmit power allocation on one or more carriers;
sending the new transmit power allocation to a MIMO co-processor via a control interface;
receiving the new transmit power allocation at the MIMO co-processor;
calculating one or more new MIMO filtering coefficients based on the new transmit power allocation; and
concurrently implementing the new transmit power allocation in the transmitter and the new MIMO filtering coefficients in the MIMO co-processor.

23. The method of claim 22, wherein the change in transmit power level is set to occur at a time tₒ and the transmitter changes the transmit power level and the MIMO co-processor implements the new MIMO filtering coefficient at a synchronized time tₒ.

24. The method of claim 22, wherein processing a request comprises generating a request to change a transmit power level defined by a new transmit power allocation.

25. The method of claim 22, wherein the MIMO co-processor is physically separate from the transmitter and connected to the transmitter via the a control interface.

26. The method of claim 22, wherein a power change notification is sent to remote receiver in communication with the transmitter to thereby notify the receiver of the change in transmit power level.

27. A method for executing a transmit power change on a new pair in a multi-channel transmitter which utilizes a MIMO co-processor comprising:
processing a request to change a transmit power level on a new pair from a lower power to a higher power;
sending the request or a modified version of the request to a MIMO co-processor via a control interface;
receiving the request or a modified version of the request at the MIMO co-processor;
calculating one or more new MIMO filtering coefficients in response to the request or a modified version of the request;
concurrently implementing the increase in transmit power with the transmitter and the new coefficient in the MIMO co-processor; and
transmitting data via the new pair at the higher power.

28. The method of claim 27, wherein the change in transmit power level is set to occur at a time tₒ and the transmitter changes the transmit power level and the MIMO co-processor implements the new MIMO filtering coefficients at a synchronized time tₒ.

29. The method of claim 27, wherein processing a request comprises receiving a request to change a transmit power level.

30. The method of claim 27, wherein the MIMO co-processor is physically separate from the transmitter and connected to the transmitter via the a control interface

31. The method of claim 27, wherein a power change notification is sent to remote receiver in communication with the transmitter to thereby notify the receiver of the change in transmit power level.
